(19) United States
(12) Patent Application Publication
(10) Pub. No.: US 2017/0017531 A1
(43) Pub. Date: Jan. 19, 2017

(54) APPLICATION OPERATING METHOD AND ELECTRONIC DEVICE USING THE SAME

(71) Applicant: Samsung Electronics Co., Ltd., Gyeonggi-do (KR)

(72) Inventors: Soon Yeon CHOI, Seoul (KR); Ji Eun BYUN, Gyeonggi-do (KR); Ga Jin SONG, Gyeonggi-do (KR); Chang Hyun AHN, Gyeonggi-do (KR)

(21) Appl. No.: 15/209,162

(22) Filed: Jul. 13, 2016

(30) Foreign Application Priority Data
Jul. 14, 2015 (KR) 10-2015-0099977

(51) Int. Cl. G06F 9/54; G06F 21/62; G06F 3/0484

(52) U.S. Cl. CPC G06F 9/542; G06F 3/0484; G06F 21/6209

(57) ABSTRACT

An electronic device includes a memory configured to store at least one application and a processor configured to connect to the memory. The processor is configured to provide a list of external devices, having the same attributes as at least part of operation attributes of the at least one application, based on a state where the at least one application is registered in a device manager, in which at least one external device is registered, to operate as a device.

### CLAIM OF PRIORITY

This application claims the benefit of priority under 35 U.S.C. §119(a) of a Korean patent application filed on Jul. 14, 2015 in the Korean Intellectual Property Office and assigned Serial number 10-2015-0099977, the entire disclosure of which is hereby incorporated by reference in its entirety.

### BACKGROUND

Field of the Disclosure

The present disclosure relates to a method for operating applications and an electronic device thereof.

Description of the Related Art

An electronic device typically supports a variety of user functions. In order to support the variety of user functions, the electronic device may execute at least one application. The execution of the application may be based on the electronic device where the application is installed.

As described above, the application may perform only a specific function through the electronic device in which the application is installed. The application may only perform functions that the electronic device is capable of without access to additional devices. Therefore, there is a limitation in operating the application, namely, the electronic device.

### SUMMARY

Aspects of the present disclosure are to address at least some of the above-mentioned problems and/or disadvantages and to provide at least some of the advantages described below. Accordingly, an aspect of the present disclosure is to provide an application operating method for operating an application through more various devices than known heretofore, and an electronic device using the same.

In accordance with an aspect of the present disclosure, an electronic device may include a non-transitory memory and at least one processor having circuitry configured to operatively connect to the memory. The at least one processor may receive a request to perform (or execute) a function provided from at least one application, and in response may verify (or identify) at least one external device which performs the function, and may provide (or output) a list including the at least one application and the at least one external device.

In accordance with another aspect of the present disclosure, an application operating method is provided. The method may include receiving a request to perform (or execute) a function provided from at least one application, verifying (or identifying) at least one external device which performs the function, and providing a list including the at least one application and the at least one external device.

Other aspects, advantages, and salient features of the disclosure will be better-appreciated by those of ordinary skill in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be explained in more detail from the following description taken in conjunction with the accompanying drawings, in which:

FIG. 1 is a block diagram illustrating a configuration of an interworking system associated with operating an electronic device according to an embodiment of the present disclosure;

FIG. 2 is a block diagram illustrating some components including a mapping module according to an embodiment of the present disclosure;

FIG. 3 is a block diagram schematically illustrating a configuration of a hub according to an embodiment of the present disclosure;

FIG. 4 is a drawing illustrating a process of operating a system associated with registering an application according to an embodiment of the present disclosure;

FIG. 5 is a drawing illustrating a process of operating a system associated with registering an application according to another embodiment of the present disclosure;

FIG. 6 is a drawing illustrating a process of operating a system associated with adding an external device operation result according to an embodiment of the present disclosure;

FIG. 7 is a drawing illustrating a process of operating a system associated with executing a set operation rule according to an embodiment of the present disclosure;

FIG. 8 is a drawing illustrating a process of operating a system associated with executing an operation rule based on an alarm application according to an embodiment of the present disclosure;

FIG. 9 is a drawing illustrating a process of operating a system associated with executing an operation rule based on a camera application according to an embodiment of the present disclosure;

FIG. 10 is a drawing illustrating a process of operating a system associated with executing an operation rule based on a camera application according to another embodiment;

FIG. 11 is a drawing illustrating a screen interface associated with registering an application according to an embodiment of the present disclosure;

FIG. 12 is a drawing illustrating an integrated operation user interface (UI) according to an embodiment of the present disclosure;

FIG. 13 is a drawing illustrating a screen interface associated with controlling operation of an application according to an embodiment of the present disclosure;

FIG. 14 is a drawing illustrating a screen interface associated with setting an operation according to an embodiment of the present disclosure;

FIG. 15 is a drawing illustrating a screen interface associated with recommending operation of a device according to an embodiment of the present disclosure;

FIG. 16 is a drawing illustrating a screen interface associated with operating interworking of a camera function according to an embodiment of the present disclosure;

FIG. 17 is a drawing illustrating a process of operating a device based on a user location according to an embodiment of the present disclosure;

FIG. 18 is a drawing illustrating a screen interface associated with setting an alarm application according to an embodiment of the present disclosure;

FIG. 19 is a block diagram schematically illustrating a configuration of an interworking system according to an embodiment of the present disclosure;

FIG. 20 is a block diagram illustrating a configuration of an electronic device according to an embodiment of the present disclosure;

FIG. 21 is a block diagram illustrating a configuration of a program block according to an embodiment of the present disclosure;

FIG. 22 is a flowchart illustrating a registration operation in an application operating method according to an embodiment of the present disclosure;

FIG. 23 is a flowchart illustrating a process of executing an operation in an application operating method according to an embodiment of the present disclosure;

FIG. 24 is a flowchart illustrating operation control in an application operating method according to an embodiment of the present disclosure; and

FIG. 25 is a flowchart illustrating a process of operating a device manager associated with operating another application according to an embodiment of the present disclosure.

Throughout the drawings, it should be noted that like reference numbers are used to depict the same or similar elements, features, and structures.

### DETAILED DESCRIPTION

Hereinafter, the present disclosure is described with reference to the accompanying drawings. However, the present disclosure is not limited to the specific embodiments shown and described herein, and it is to be understood by a person of ordinary skill in the art that all modifications and/or, equivalents and substitutes are within the scope and technical range of the present disclosure, and not only those expressly shown and described herein. With respect to the descriptions of the drawings, like reference numerals refer to like elements.

In the disclosure, the expressions “have”, “may have”, “include” and “comprise”, or “may include” and “may comprise” used herein indicate existence of corresponding features (e.g., elements such as numeric values, functions, operations, or components) but do not exclude presence of additional features.

In the disclosure, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The expressions such as “1st”, “2nd”, “first”, or “second”, and the like used in various embodiments of the present disclosure may refer to various elements irrespective of the order and/or priority of the corresponding elements, but do not limit the corresponding elements. The expressions may be used to distinguish one element from another element. For instance, both “a first user device” and “a second user device” indicate different user devices from each other irrespective of the order and/or priority of the corresponding elements. For example, a first component may be referred to as a second component and vice versa without departing from the scope of the present disclosure.

It will be understood that when an element (e.g., a first element) is referred to as being “(operatively or communicatively) coupled with/to” or “connected to” another element (e.g., a second element), it can be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

Depending on the situation, the expression “configured to” used herein may be used as, for example, the expression “suitable for”, “designed to”, “adapted to”, or “made to”. The term “configured to” is not limited to a definition of “specifically designed to” in hardware. Instead, the expression “a device configured to” may be understood as meaning that the device may be operable together with another device or other components. For example, a “processor configured to perform A, B, and C” may refer to a generic-purpose processor (e.g., a central processing unit (CPU) or an application processor) which may perform corresponding operations by executing one or more software programs which stores a dedicated processor (e.g., an embedded processor) for performing a corresponding operation.

Terms used in this specification are used to describe specified embodiments of the present disclosure and do not limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect, unless expressly so defined herein in various embodiments of the present disclosure. In some cases, even if terms are such which are defined in the specification, they may not be interpreted to exclude embodiments of the present disclosure.

Electronic devices according to various embodiments of the present disclosure may include at least one of, for example, smart phones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices (e.g., smart glasses, head-mounted-devices (HMDs), an electronic apparel, electronic bracelets, electronic necklaces, electronic appcessories, electronic tattoos, smart mirrors, or smart watches).

Hereinafter, electronic devices according to various embodiments of the present disclosure will now be described with reference to the accompanying drawings. The term “user” used herein may refer to a person who uses an electronic device or may refer to a device (e.g., an artificial electronic device) that uses an electronic device.

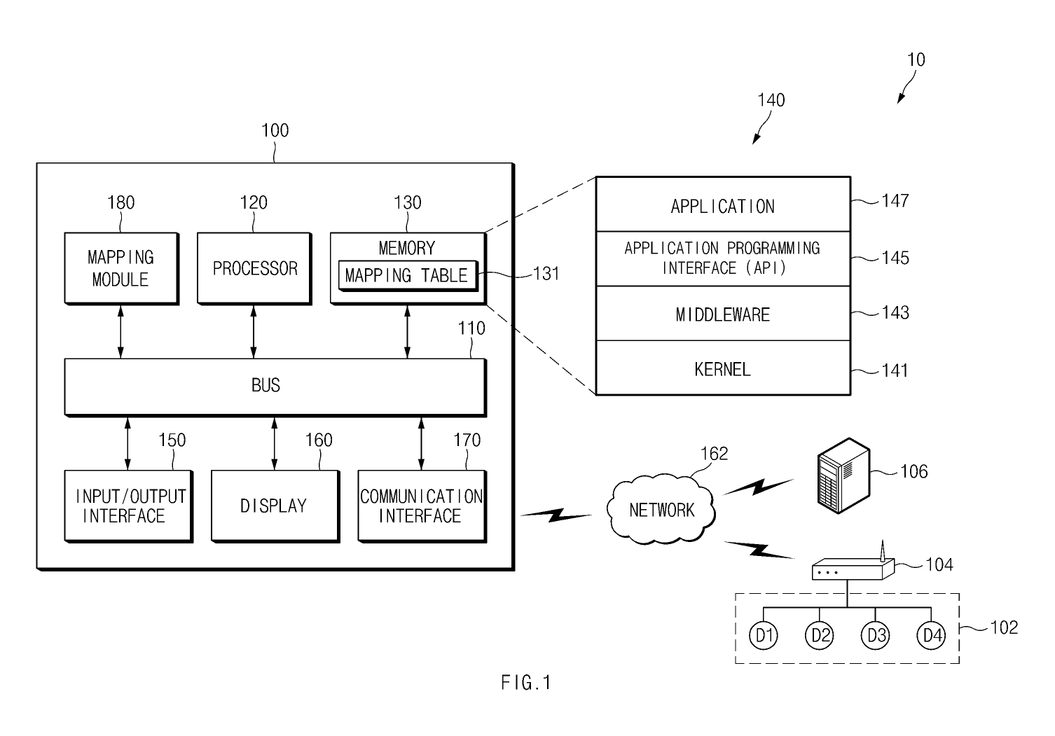

FIG. 1 is a block diagram illustrating a configuration of an interworking system associated with operating an electronic device according to an embodiment of the present disclosure.

Referring now to FIG. 1, an interworking system 10 which operates an electronic device 100 may include the electronic device 100, a network 162, at least one external device 102, and a device manager (e.g., a module (or a processor), which may include software or hardware in at least one of the electronic device 100, a server 106, or a hub 104, the module managing connection with the at least one external device 102).

In the above-mentioned interworking system 10, the electronic device 100 may register at least one installed application as “a device (or a virtual device)” in the device manager. When executing the application, the electronic device 100 may control the at least one external device 102 (e.g., an external device) connected to the device manager to operate together with the application). According to an embodiment of the disclosure, the electronic device 100 may control operation of an installed application in the same manner as the at least one external device 102. The electronic device 100 may provide an integrated user interface (UI) associated with operating the application and the at least one external device 102 in an integrated manner. For example, the electronic device 100 may arrange a specific layer on an upper portion of an application execution screen and may define the same attributes (or settings) as attributes (or settings) for controlling the external device 102. Therefore, the electronic device 100 may more easily operate its functions without distinction of the application or the external device 102. In connection with operating the function, the electronic device 100 may perform its registration function such that the device manager recognizes an application installed in the electronic device 100 as a device such as an external device and communicate with the application. The electronic device 100 may perform (or execute) a function of searching the external device 101, which has the same attributes as the application registered as the device. The electronic device 100 may control operation of the found external device 102 and the application.

The network 162 may support the establishment for example, of a wired communication channel, or a wireless communication channel, between the electronic device 100, the hub 104, and the server 106. Additionally, if the hub 104 includes a wireless communication interface, the network 162 may support to establish a wireless communication channel of the hub 104. The network 162 may include, for example, at least one device element which may support a wireless communication function (e.g., various wireless communication schemes such as second generation (2G), third generation (3G), fourth generation (4G), long term evolution (LTE), and fifth generation (5G), a wireless access communication function (e.g., a wireless-fidelity (Wi-Fi) communication function), and the like. Alternatively, the network 162 may include a telecommunications network, for example, at least one of a computer network (e.g., a local area network (LAN) or a wide area network (WAN)), the Internet, or a telephone network. Alternatively, the network 162 may include a local-area communication network. In the case that a local-area communication network is included, the network 162 may communicate data based on a local-area communication channel between the electronic device 100 and the server 106 or between the electronic device 100 and the hub 104, or between the server 106 and the hub 104.

The server 106 may connect with the electronic device 100 over the network 162. The server 106 may establish a wireless communication channel in response to a request of the electronic device 100. The server 106 may receive, for example, specific data and requests from the electronic device 100. Alternatively, the server 106 may send specific data and instructions to the electronic device 100. According to an embodiment, the server 106 may receive registration information, for registering an application as a device (e.g., such as the external device), from the electronic device 100. Also, the server 106 may receive function control information associated with operating an application from the electronic device 100. The server 106 may share the received registration information and the received function control information with the hub 104. According to an embodiment of the present disclosure, the server 106 may send the received registration information and the received function control information to the hub 104.

With continued reference to FIG. 1, at least part of the hub 104 may include, for example, the same or similar configuration to the server 106. According to an embodiment, the hub 104 may establish a communication channel with the electronic device 100 and may receive registration information, for registering at least one application as at least one device, from the electronic device 100. Also, the hub 104 may receive function control information associated with operating an application from the electronic device 100. The hub 104 may connect with the at least one external device 102. The hub 104 may store a device list table for common control between the application and the at least one external device 102. The hub 104 may convert a command associated with operating an application into a command to be applied to control of the external device 102. The hub 104 may link an application 147 according to the at least one external device's 102 attributes. For example, the hub 104 may obtain audio information output attributes from among attributes of a music application. The hub 104 may classify a device (e.g., an audio device, a radio device, a compact disc (CD) player, a television (TV) device, a siren device, and the like) having the audio information output attributes among the at least one external device 102 as a device having the substantially same attributes as the music application.

The at least one external device 102 may be an Internet of Things (IoT) device and may include an electronic device which may establish a communication channel with a peripheral device (e.g., the electronic device 100, the hub 104, the server 106, and the like). For example, the at least one external device 102 may include various electronic devices such as a light switch, a thermostat, a presence sensor, a contact sensor, an alarm device, an information display device, a door device, and the like. The at least one external device 102 may include specific attributes. For example, the light switch may include power-on attributes, power-off attributes, power level adjustment attributes, etc., and the like. The alarm device may include alarm-on attributes, alarm-off attributes, alarm level adjustment attributes, and the like. The thermostat may include temperature sensing attributes, temperate sensing stop attributes, attributes of outputting heated or cooled air based on a sensed temperature and a specific temperature, and the like. The information display device may include, for example, information such as device-on attributes, device-off attributes, attributes of adjusting a size or brightness of an output screen, attributes of changing the source of an image, or attributes of adjusting a volume of the audio output and the like. The door device may include door opening attributes, door closing attributes, door lock setting attributes, and the like.

In FIG. 1, this embodiment is exemplified as the hub 104 and the server 106 are arranged as separate components. However, various embodiments may not be limited in this manner. For example, in various embodiments, the hub 104 may be implemented as a function of the server 106 without the physical presence of the server 106. Also, if the server 106 is replaced with the hub 104, a system may be implemented wherein an interface is connected between the hub 104 and the at least one external device 102. Therefore, a description below will be given of device registration of an application and an operation to interwork with the external device 102 with reference to the hub 104.

The electronic device 100 may include a bus 110, at least one processor 120, a non-transitory memory 130, an input and output interface 150, a display 160, a communication interface 170, and a mapping module (or a mapping processor) 180.

The bus 110 may include, for example, a circuit which connects the components 120 through 180 with each other and transmits a communication signal (e.g., a control message and/or data) between the components 120 through 180. For example, the bus 110 may connect the communication interface 170 with the mapping module 180. The bus 110 may send application registration information written by the mapping module 180 to the hub 104 (or the server 106, hereinafter be described with reference to the hub 104) through the communication interface 170.

The at least one processor 120 may include one or more of a central processing unit (CPU), an application processor (AP), or a communication processor (CP). The processor 120 may comprise hardware circuitry and may also be referred to as a microprocessor, integrated circuit, or controller. For example, the at least one processor 120 may perform calculation or data processing about control and/or communication of at least another of the components of the electronic device 100. According to an embodiment of the disclosure, the at least one processor 120 may install at least one application based on a user input, detecting an external device not currently associated with an application or in response to a specific schedule. According to an embodiment of the disclosure, the processor 120 may receive an application program from a web server and the like and may install the received application program in the electronic device 100. The at least one processor 120 may register the at least one application, installed in the electronic device 100, as a device. The at least one processor 120 may extract attributes information in connection with registering the application 147 as the device. The processor 120 may display a list of the at least one external device 102 having the substantially same attributes as the application in connection with operating the application registered as the device. The at least one processor 120 may select an application and the external device 102 to operate, in response to a selected input signal. The at least one processor 120 may send data according to execution of an application to the external device 102 to be output or to control an operation of the external device 102. In this regard, the at least one processor 120 may include at least part of the mapping module 180, or at least one processor may be configured with at least part of the mapping module 180.

The memory 130, which is non-transitory, may include a volatile and/or non-volatile memory. The memory 130 may store, for example, a command or data associated with at least another of the components of the electronic device 100. The command may be executed by at least one of the processor 120 or the mapping module 180. The command may include a command to generate registration information associated with registering an application, a command to provide registration information, an input collection command associated with operating an application, a command to send a collected input event to the hub 104, a command to send data generated based on operation of an application to the hub 104, and the like.

According to various embodiments of the disclosure, the memory 130 may store a mapping table 131. As described above, the mapping table 131 may include information (e.g., information mapped to a device identifier (ID) (or a unique (“exclusive”) ID) and an event ID) in a form distinguishing at least one application from the external device 102 connected to the hub 104 (or the server 106).

According to various embodiments of the disclosure, the memory 130 may store software and/or a program 140. The program 140 may include, for example, a kernel 141, a middleware 143, an application programming interface (API) 145, and/or at least one application program 147 (or “at least one application”), and the like. At least part of the kernel 141, the middleware 143, or the API 145 may be referred to as an operating system (OS).

The kernel 141 may control or manage, for example, system resources (e.g., the bus 110, the at least one processor 120, the mapping module 180, or the memory 130, and the like) used to execute an operation or function implemented in the other programs (e.g., the middleware 143, the API 145, or the application program 147). Also, as the middleware 143, the API 145, or the application program 147 accesses a separate component of the electronic device 100, the kernel 141 may provide an interface which may control or manage system resources.

The middleware 143 may play a role as, for example, communicate data between the API 145 or the application 147 and the kernel 141. Also, the middleware 143 may process one or more work requests, received from the application 147, in order of priority. For example, the middleware 143 may grant priority which may use system resources (the bus 110, the at least one processor 120, the mapping module 180, or the memory 130, and the like) of the electronic device 100 to at least one application of the application area 147. For example, the middleware 143 may perform scheduling or load balancing for the one or more work requests by processing the one or more work requests in order of priority granted to the at least one of the at least one application program 147.

The API 145 may include, for example, an interface in which the application area 147 controls a function provided from the kernel 141 or the middleware 143. For example, the API 145 may include at least one interface or function (e.g., instruction) for file control, window control, image processing, or text control, and the like.

With continued reference to FIG. 1, the application area 147 may include one or more applications. For example, the application area 147 may include a music application, an exercise (or healthcare) application, an alarm application, and the like. At least one of the at least one or more applications included in the application area 147 may be registered as a device (or a virtual device) in the hub 104 based on a user setting. Alternatively, a registration state of the at least one application registered as the device may be cancelled under a user control. The application area 147 may also include application data. For example, the application area 147 may include information about an application name, information about a developer, information about a program name and a corresponding version of a program, information (e.g., intent) about an event to be sent, information (e.g., intent filter) about an event to be received from the outside, information about the right to allow an application to use resources of the electronic device, information about type of an account necessary for a program, and the like.

The input and output interface 150 includes hardware and may play a role as, for example, an interface which may transmit a command or data input from a user or another external device to another component (or other components) of the electronic device 100. Also, input and output interface 150 may output a command or data received from another component (or other components) of the electronic device 100 to the user or the other external device. The input and output interface 150 may include, for example, at least one physical button and touch button, a touch pad, or a touch screen, and the like. Also, the input and output interface 150 may include an input structure such as an electronic pen. Also, the input and output interface 150 may include an audio device for processing an audio signal, such as an audio processor. The audio device may output audio data associated with executing an application. The above-mentioned function of outputting the audio data may be omitted based on a user setting or a user input. The input and output interface 150 may output audio information to be output based on executing an application. According to various embodiments of the disclosure, if audio information based on execution of an application is set to be output through at least one of the at least one external device 102, the input and output interface 150 may not output the audio information.

The display 160 may include, for example, a thin-film technology, a liquid crystal display (LCD), a light emitting diode (LED) display, an organic LED (OLED) display, a microelectromechanical systems (MEMS) display, or an electronic paper display. The display 160 may display, for example, a variety of content (e.g., text, images, videos, icons, or symbols, and the like) to the user. The display 160 may include a touch screen, and may receive, for example, a touch, a gesture, a proximity “touch”, or a hovering input using an electronic pen or part of a body of the user.

The display 160 may output at least one screen associated with a device registration function of the electronic device 100. Also, the display 160 may output at least one screen associated with a device operation function. According to an embodiment, the display 160 may display (or output) a list of at least one of the at least one external device 102, associated with attributes of an application which is requested to register. Also, the display 160 may display a screen corresponding to execution of an application and a list of the at least one external device 102 which may interwork with an application. The display 160 may output a control window associated with controlling the at least one external device 102 which operates to interwork with an application.

The communication interface 170 may establish communication between, for example, the electronic device 100 and the device manager. For example, the communication interface 170 may connect to the network 162 through wireless communication and may communicate with the device manager. The communication interface may include hardware such as a transmitter, receiver, transceiver, antenna(s), codec, etc.

The wireless communication between the communication interface 170 and, for example, the network, may use, for example, at least one of long term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM), and the like as a cellular communication protocol. Also, the wireless communication may include, for example, local-area communication. The local-area communication may include, for example, at least one of wireless-fidelity (Wi-Fi) communication, Bluetooth (BT) communication, near field communication (NFC), magnetic stripe transmission (MST) communication, or global navigation satellite system (GNSS) communication, and the like. According to an embodiment of the disclosure, the communication interface 170 may provide application registration information to the hub 104. The communication interface 170 may receive a list of the at least one external device 102 from the hub 104. The communication interface 170 may send specific control information (e.g., a device control command) to an external device, which interworks through the hub 104, based on operation of an application.

The GNSS may include, for example, at least one of a global positioning system (GPS), a Glonass, a Beidou navigation satellite system (hereinafter referred to as “Beidou”), or a Galileo (i.e., the European global satellite-based navigation system) according to an available area or a bandwidth, and the like. Hereinafter, the “GPS” used herein may be interchangeably with the “GNSS”. A wired communication interface may include at least one of, for example, a universal serial bus (USB), a high definition multimedia interface (HDMI), a recommended standard 232 (RS-232) interface, or a plain old telephone service (POTS) interface, and the like.

The mapping module 180 is executed, for example, by an integrated circuit, may perform a variety of signaling and data processing in connection with registering an application installed in the electronic device 100 as a device. Also, the mapping module 180 may perform a variety of signaling and data processing for interworking with the external device 102 in connection with operating an application. In this regard, the mapping module 180 may be implemented to include the at least one processor 120 or may operate as at least part of the processor 120. According to an embodiment, the mapping module 180 may be implemented in the form of software that is loaded into hardware for execution, and may be uploaded to the at least one processor 120 to provide a function of registering an application as a device (e.g., a function of virtually processing the application to operate the mapping module 180 as one of the at least one external device 102). Alternatively, the mapping module 180 may be implemented in the form of independent hardware, and registers the application as the device to perform data processing. The function of registering the application as the device may be a function such that the device manager may recognize an application of the electronic device 100 as a device (e.g., an object or thing). In this regard, the electronic device 100 may assign (or allow) an application a unique (i.e. “exclusive”) identification number such that the device manager may recognize the application as the device. The electronic device 100 may register a related application as a device by providing the assigned unique identification number (or allowed unique identification number) and other information associated with an application (e.g., a name or function of the application). For example, the electronic device 100 may register a music play application as a music player in the device manager. As described above, the mapping module 180 may be implemented in the form of at least one of software or hardware.

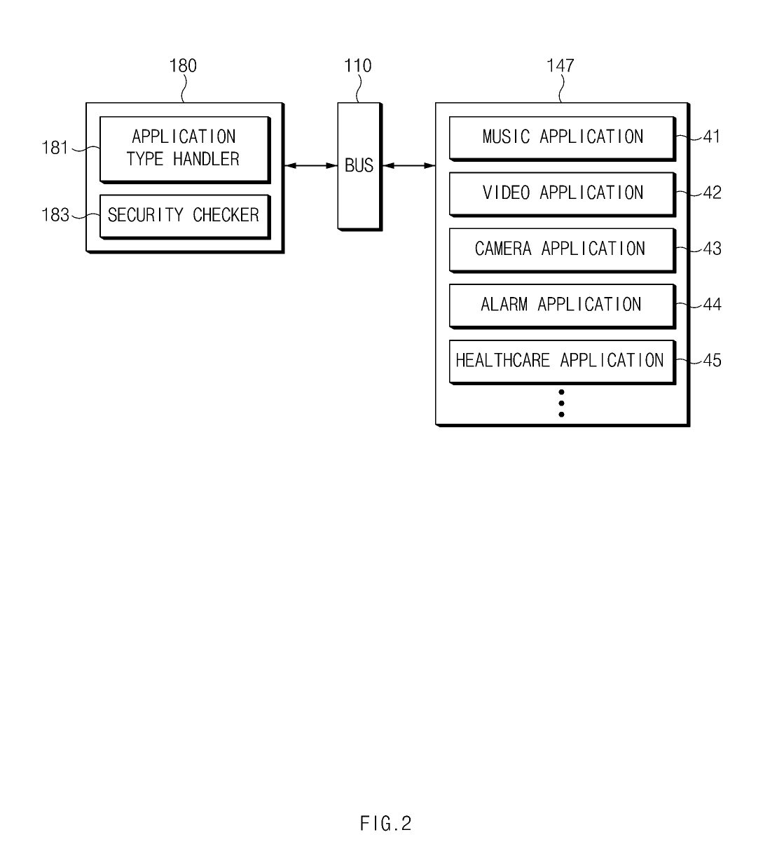

FIG. 2 is a block diagram illustrating some components including a mapping module according to an embodiment.

Referring now to FIG. 2, a mapping module 180 according to an embodiment may include an application type handler 181 and a security checker 183. At least one application area 147 may include, for example, a music application 41, a video application 42, a camera application 43, an alarm application 44, a healthcare application 45, and the like. As applications are additionally installed in the electronic device 100, types or the number of applications included in the at least one application 147 may be increased. Alternatively, as applications are deleted from the electronic device 100, types or the number of applications included in the at least one application 147 may be decreased. The application type handler 181 and the security checker 183 may be formed by integrated circuits such as one or more processors. Or, at least part of a processor may include the application type handler 181 and the security checker 183.

The mapping module 180 may provide a user interface for registering an application as one device (or one virtual device). The mapping module 180 may provide (or output) a list of at least one external device 102 of FIG. 1, having the substantially same or similar attributes to the application registered as the device and may provide control guide information. The mapping module 180 may search the external device 102, which has the substantially same attributes as the application, registered as the device, using an interworking manager (e.g., an integrated management program or application). The interworking manager may operate the application registered as the device and an external device to interwork with each other. The mapping module 180 may provide the found external device 102 to be selected by a user of an electronic device 100 of FIG. 1. The mapping module 180 may provide a user interface for controlling the selected external device 102 and the application. According to an embodiment of the disclosure, the mapping module 180 may provide a user interface for simultaneously controlling the external device, having the substantially same attributes as the application registered as the device, and the application.

According to various embodiments of the present disclosure, when the music application 41 is executed, the mapping module 180 may provide a speaker having a specific position, which may establish a communication channel with the electronic device 100, as an external device, or may automatically process data associated with the music application 41 to be output through the speaker. According to various embodiments of the present disclosure, when the camera application 43 is requested to be executed, the mapping module 180 may receive an image from a specific external device (e.g., another camera or an internet protocol (IP) camera) disposed in a specific position) which has substantially the same attributes as at least some of attributes of the camera application 43. The mapping module 180 may provide the image received from the external device and/or an image received in a camera sensor disposed in the electronic device 100 as a preview on a screen associated with the camera application 43. The mapping module 180 may provide an image capturing function and the like based on a user input.

With continued reference to FIG. 2, the application type handler 181 may control a path, through which an event is sent, in the mapping module 180. The application type handler 181 may determine a path of an event based on information in a mapping table 131 of FIG. 1. The application type handler 181 may convert an event type of an internal application to suit a device typ. For example, the application type handler 181 may convert a command, a status value, and the like, which received from an application, into a device ID and an event ID using the mapping table 131. The application type handler 181 may determine whether to process a command, a status value, and the like in the electronic device 100 or whether to send the command, the status value, and the like to a hub 104 (or a server 106) of FIG. 1, based on a specific policy or setting. The application type handler 181 may send the command and the status value based on the determined result.

The security checker 183 may check the validity of an event (e.g., may check the validity of the event based on reference information generated to determine whether the event is valid) in the mapping module 180 and may control transmission of the event. The security checker 183 may control an input and output of the corresponding event based on whether the event is secure. If a valid event is against a policy data, the security checker 183 may block an event from being sent. The policy data may include, for example, a variety of security policy information defined in the electronic device, important data (determined based on a specific important data level based on a policy and the like), and the like. The security checker 183 may check an operation of a function based on the policy data and may prevent an event from being processed, based on a specific policy or setting, if necessary.

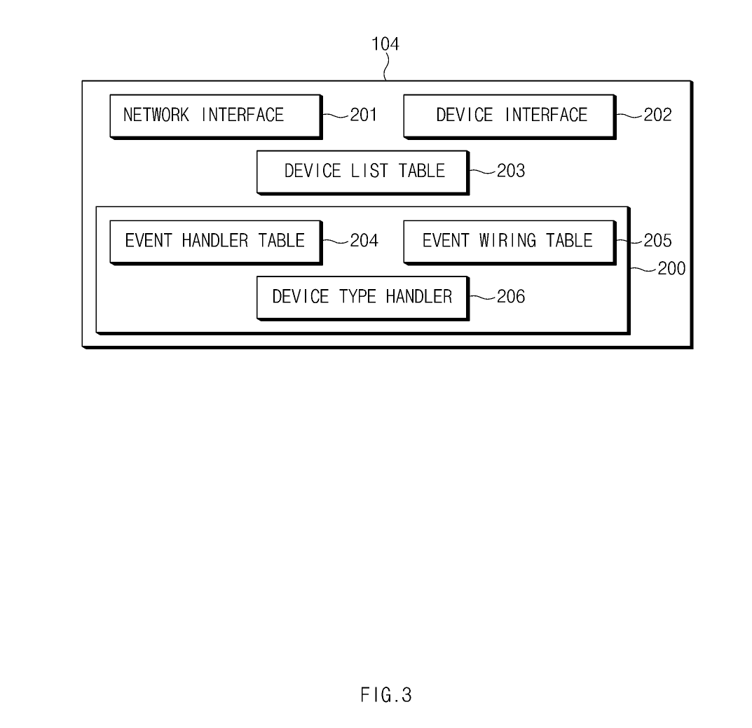

FIG. 3 is a block diagram schematically illustrating a configuration of a hub according to an embodiment of the disclosure.

Referring now to FIG. 3, a hub 104 may include a network interface 201, a device interface 202, a device list table 203, and a device manager 200 (e.g., a module includes at least one of an event handler table 204, an event wiring table 205, or a device type handler 206). Alternatively, the hub 104 may include a communication module (e.g., the network interface 201 and the device interface 202), a memory device which stores the device list table 203, the event handler table 204, and the event wiring table 205, and the device manager (e.g., a processor corresponding to the device type handler 206).

The network interface 201 may establish a communication channel with a server 106 or an electronic device 100 of FIG. 1 over a network 162 of FIG. 1. The network interface 201 may receive, for example, registration information of an application from the electronic device 100 (or the server 106). The network interface 201 may send information such as a device ID of at least one external device 102 of FIG. 1 and an event ID to the server 106 or the electronic device 100.

The device interface 202 may include at least one communication module which may connect with the external device 102. For example, the device interface 202 may include a wired communication module for communicating with a light switch, a wired and wireless communication module for communicating with at least one sensor, a wired and wireless communication module for communicating with a camera, and the like. The device interface 202 may receive the device ID of the at least one connected external device 102, the event ID, attributes information, and the like. The device interface 202 may provide the device ID, the event ID, the attributes information, and the like to the device type handler 206.

With continued reference to FIG. 3, the device list table 203 may comprise a table for managing external devices registered in the device manager 200 in connection with the specific electronic device 100. The device list table 203 may include information such as a device ID, a location, attributes information, and a command associated with controlling a corresponding external device. The device list table 203 may be updated based on connection or disconnection of the external device 102.

The event handler table 204 may be a table used to convert an event received from the electronic device 100 into a format which may be sent to external devices which have the substantially same attributes as each other. For example, the event handler table 204 may include information for converting a command sent from an application into a command which may be understood by the external device 102 which has the substantially same attributes as the application. In the embodiment, application and external device attributes may represent the status of the application or external device or the output of a sensor. For example, a light switch may have as an attribute whether it is on or off or a door may indicate if it is open or closed. An application may as an attribute indicate if the application is on or identify a file opened in the application. An attribute may also indicate if a presence sensor detects a person or a light sensor may output the level of illumination in a room.

The event wiring table 205 may be a table provided for defining a source device ID, a target device ID, a location, capability, action, and the like. The event wiring table 205 may provide the above-mentioned information (e.g., the source device ID, the target device ID, the location, the capability, and the action), associated with external devices to interwork and operate with an application which is registered as a device, to the device type handler 206.

The device type handler 206 may send a command to the at least one external device 102 (e.g., a contact sensor, a presence camera, a living room speaker, and the like) connected to the server 106 or the hub 104. According to an embodiment, the device type handler 206 may change a device command to a protocol specific command and may send the changed protocol specific command to a corresponding external device. If the external device 102 connects with the hub 104, the device type handler 206 may update the device list table 203 based on a device ID, an event ID, and attributes information, received from the connected external device 102.

As described above, the device manager 200 may include the event handler table 204, the event wiring table 205, the device type handler 206, and the like. The device manager 200 may be implemented in software-or hardware, and disposed in the server 106, or the electronic device 100, or the hub 104.

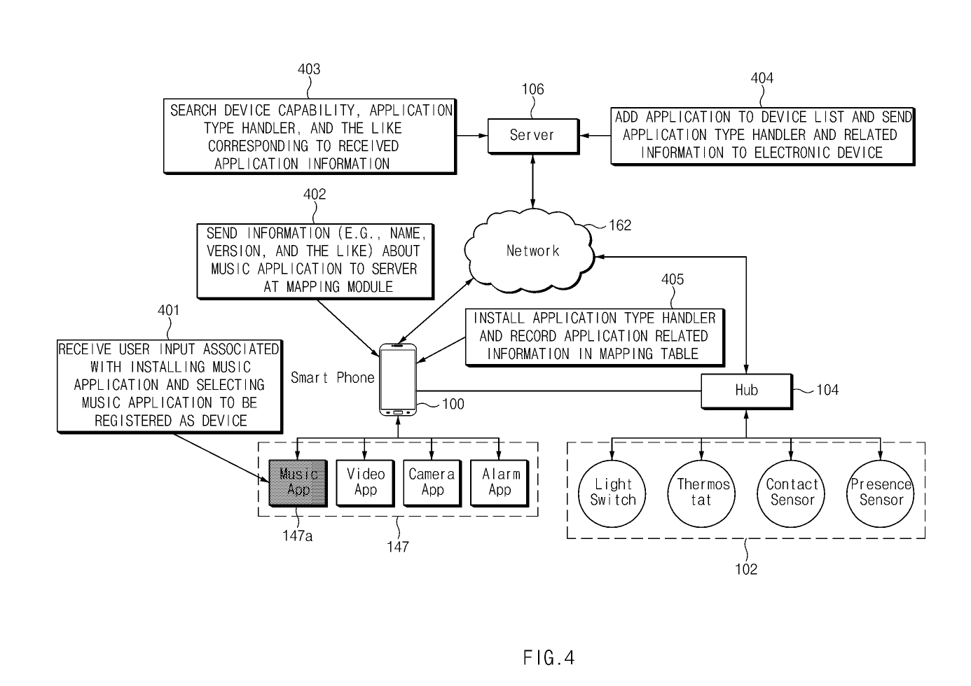

FIG. 4 is a drawing that illustrates a process of operating a system associated with registering an application according to an embodiment of the disclosure.

Referring now to FIG. 4, according to an embodiment of the disclosure, an application device registering system may include an electronic device 100 (e.g., a smart phone), in which at least one application 147 is installed or may be installed, a server 106, a hub 104, and at least one external device 102.

The electronic device 100 may include at least one installed application from the application area 147. The electronic device 100 may provide a function of searching the at least one installed application 147. For example, the electronic device 100 may provide display of an icon or a menu associated with searching the application area 147. The electronic device 100 may output a search screen, for selecting the at least one application 147 in response to a user input, on a display 160 of FIG. 1.

With reference to FIG. 4, at operation 401, the electronic device 100 may receive a user input associated with installing a specific application (e.g., a music application 147a) and selecting the application to be registered as a device.

At operation 402, a mapping module 180 of the electronic device 100 may send information (e.g., a name, a version, and the like) about the music application 147a to the server 106. According to an embodiment of the disclosure, the music application information may include the name of the application 147, the type of application 147, the version number of the application 147, and the installed location of the application 147. The music application may provide ‘type: app/device id: Music(App)/package:music.app.samsung/ver: 1.0/location:smart phone’.

At operation 403, the server 106 may search the electronic device 100 for capability and an application type handler, corresponding to the received application information.

At operation 404, the server 106 may add an application to a device list and may send the application type handler and related information to the electronic device 100.

At operation 405, the electronic device 100 may install the application type handler and may record application related information in a mapping table 131 of FIG. 1. According to an embodiment of the disclosure, the electronic device 100 may update an application ID, a device ID, and an attributes value (e.g., capability) in the mapping table 131.

As described above, if an application to be registered as a device is selected, the electronic device 100 may install an application type handler for changing a device attributes value associated with the corresponding application. The application type handler may be provided in a state where it is included in the corresponding application and may be installed in a process of installing the application. Alternatively, if an application to be registered as a device is selected or if a request to install an application is generated, the electronic device 100 may receive an application type handler from the server 106 and may install the application type handler.

According to various embodiments of the disclosure, the electronic device 100 may provide an option to automatically register an application as a device in a device manager such as the hub 104, or the server 106, when the application is installed. The electronic device 100 may periodically check the server 106 and may determine whether a most-recent version of an application type handler of the currently installed application is registered in the server 106. If the most-recent version of the application type handler of the currently installed application is registered in the server 106, the electronic device 100 may receive the application type handler of the most-recent version and may update its application type handler.

In a process of installing the application and registering the application as a device, the mapping table 131 may store the values in Table 1 below in the mapping table 131. Empty areas in the Tables below may refer to areas, in which information may be written, in a memory assigned to the mapping table 131.

TABLE 1

| App ID | Device ID | Capability |
|---|---|---|
| Music.app.semsung | Music(App) | Capability.musicPlayer |

An application type handler 181 of FIG. 2 may have values in Table 2 below.

TABLE 2

| | | | | |
|---|---|---|---|---|
| App ID | Attribute | Property | Command | Function |

| | | |
|---|---|---|
| Music.app.semsung | play | Intent_PLAY |
| Music.app.semsung | pause | Intent_PAUSE |

A device list table 203 of FIG. 3 may have values in Table 3 below.

TABLE 3

| Device ID | Location | Capability | Attributes | Command |
|---|---|---|---|---|
| Music(App) | Smart | Capability.musicPlayer | | play, |
| | Phone | | | pause, |
| | | | | stop |

An event table (e.g., an event wiring table 205 of FIG. 3) may have a state where a separate value is not stored in Table 4 below.

TABLE 4

| | | | | | |
|---|---|---|---|---|---|
| Event | Source | Target | Location | Capability | Action |
| | Device ID | Device ID | | | |

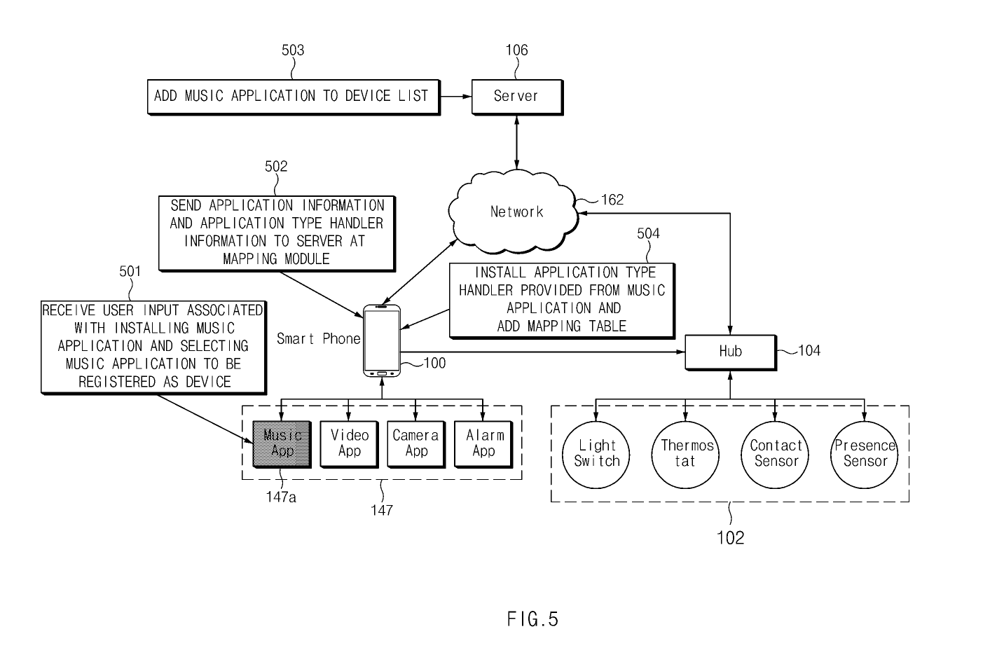

FIG. 5 is a drawing illustrating a process of operating a system associated with registering an application according to another embodiment of the disclosure.

Referring now to FIG. 5, an application registration related system may include, for example, an electronic device 100 (e.g., a smart phone) in which at least one application 147 of FIG. 2 is installed, a network 162, a server 106, a hub 104, and at least one external device 102.

At operation 501, the electronic device 100 may receive a user input associated with installing a specific application (e.g., a music application 147a) and selecting the application to be registered as a device. According to various embodiments of the disclosure, the electronic device 100 may receive a user input for selecting the previously installed application area 147 as a device.

At operation 502, a mapping module 180 of the electronic device 100 may send application information and application type handler information to the server 106. In this regard, the electronic device 100 may obtain application information and application type handler information associated with the selected application. The application information and the application type handler information may be recorded in the corresponding application or may be recorded in a certain location of a memory 130 of FIG. 1. The application information may be written in the form of, for example, ‘type: app/device id: Music(App)/package:music.app.semsung/ver:1.0/location:smart phone/capability: capability.musicPlayer’.

At operation 503, the server 106 may add the music application 147a to a device list based on the application information and the application type handler information, received from the electronic device 100.

At operation 504, the electronic device 100 may install an application type handler provided from the music application area 147 and may add a mapping table.

As described above, the electronic device 100 may send to the server 106, an application type handler information, for changing a device attributes value associated with a corresponding application, to omit a step in which the server 106 searches an application type handler.

In the above-mentioned process of installing the application and registering the application as the device, the mapping table 131 may have the values in Table 1 above. Also, defined information about an application type handler 181 of FIG. 2 may have the values in Table 2 above. Also, a device list table 203 of FIG. 3 and an event table (e.g., an event wiring table 205 of FIG. 3) may have the values in Tables 3 and 4 above.

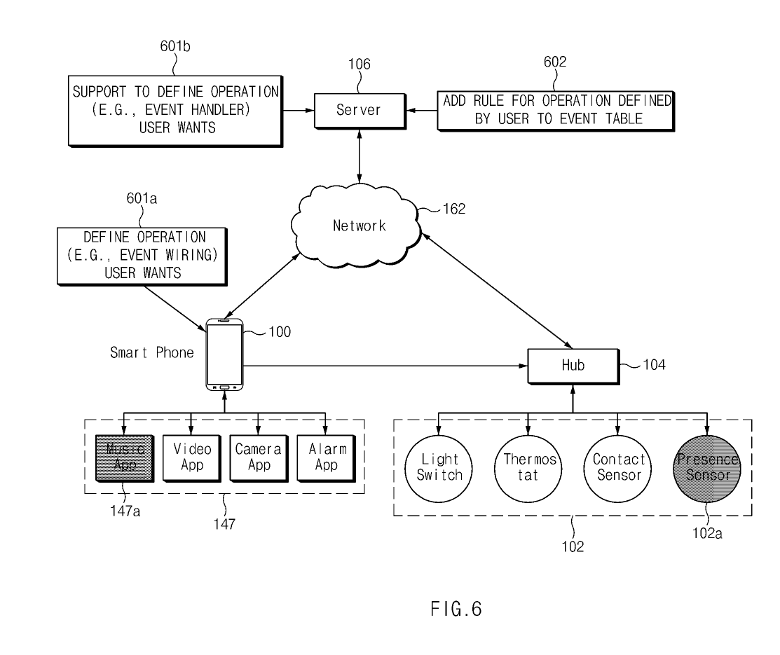

FIG. 6 is a drawing illustrating a process of operating a system associated with adding an external device operation result according to an embodiment.

Referring now to FIG. 6, the system associated with adding the operation rule may include an electronic device 100 (e.g., a smart phone) in which at least one application from application area 147 is installed, a network 162, a server 106, a hub 104, and at least one external device 102.

At operation 601a, the electronic device 100 may define an operation its user wants for a specific application (e.g., a music application 147a) based on a user input. For example, the electronic device 100 may perform event wiring (e.g., an operation of writing information in an event table, used to instruct a function to be performed in a specific device or application based on a specific event) associated with the music application 147a and a presence sensor 102a. The electronic device 100 may provide a screen interface for executing an application and defining an operation to define the operation the user wants.

Alternatively, at operation 601b, the server 106 may support to define the operation the user wants. For example, the server 106 may support to define an event handler. In this regard, the server 106 may support connection of the electronic device 100 and may provide a screen associated with defining a user operation to the electronic device 100. The server 106 may receive user operation definition information, input through the corresponding screen, from the electronic deice 100.

According to various embodiments of the disclosure, if the presence sensor 102a located in a kitchen of the user senses him or her, the electronic device 100 (or the sever 106) may receive user operation definition information to execute the music application 147a of the electronic device 100 from him or her.

At operation 602, the server 106 may add a rule for an operation defined by the user to an event table. Therefore, if a specific external device (e.g., the presence sensor 102a) operates based on the user operation definition information, the server 106 may search for an application (e.g., the music application 147a), registered as a device in the electronic device 100, having the substantially same attributes as the corresponding external device and may support the corresponding application.

In connection with adding the operation rule, information associated with a mapping table 131 of FIG. 1 and an application type handler 181 of FIG. 2 may have the values in Tables 1 and 2 above. Additional values may be added to tables 3 and 4 above associated with operating the presence sensor and the music application 147a as a device in connection with a rule in the event table.

A device list table 203 of FIG. 3 may have values in Table 5 below.

| Device ID | Location | Capability | Attributes | Command |
|---|---|---|---|---|
| Music(App) | Smart | Capability.musicPlayer | | Play, pause, |
| | Phone | | | stop |
| Presence | Kitchen | Capability.presenceSensor | Presence(true, | |
| Sensor | | | false) | |

The event table (e.g., an event wiring table 205 of FIG. 3) may be written in Table 6.

| | Source | Target | | | |
|---|---|---|---|---|---|
| Event | Device ID | Device ID | Location | Capability | Action |
| Presence(true) | Presence | Music(App) | Smart | Capa.musicPlayer | play |
| | Sensor | | Phone | | |

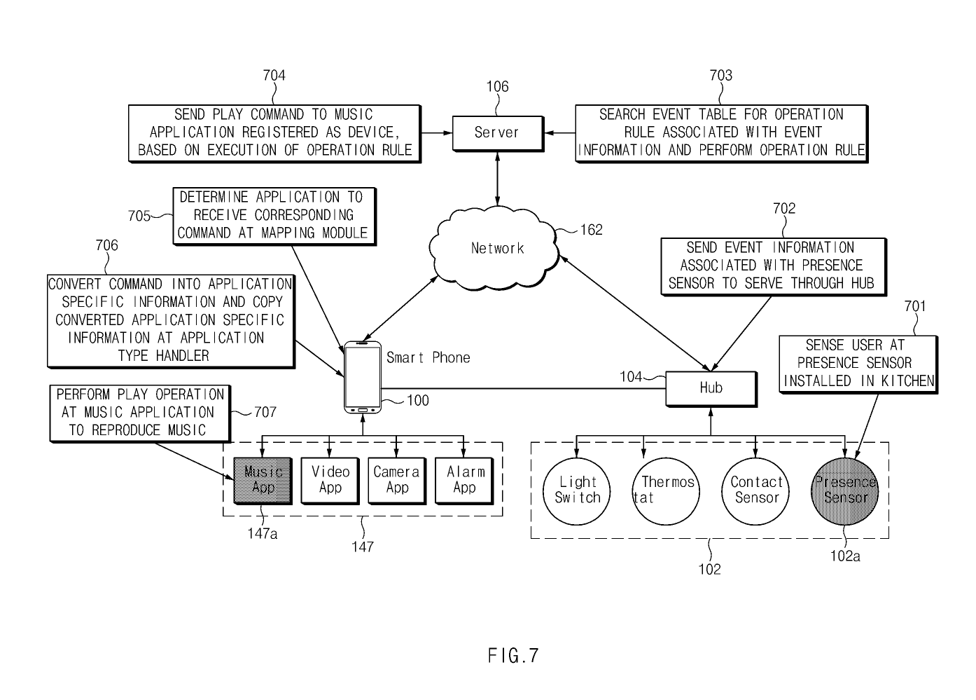

FIG. 7 is a drawing illustrating a process of operating a system associated with executing a set operation rule according to an embodiment.

Referring now to FIG. 7, the system associated with executing the operation rule may include an electronic device 100 (e.g., a smart phone) in which at least one application 147 is installed, a network 162, a server 106, a hub 104, and at least one external device 102.

In connection with executing the operation rule, at operation 701, an external device (e.g., a presence sensor 102a) installed in a certain location (e.g., a kitchen) may detect user motion or a user location. The presence sensor 102a may send the detected user motion information to the hub 104.

If the hub 104 receives sensor information from the presence sensor 102a, at operation 702, the hub 104 may send event information associated with the presence sensor 102a to the server 106. The event information sent to the server 106 may be written as, for example, ‘device id:Presence Sensor/event: presence(true)’.

At operation 703, the server 106 may search an event table for an operation rule associated with event information and may perform the operation rule. The event table may be, for example, an event wiring table 205 of FIG. 3. The server 106 may search the event wiring table 205 for information defined in connection with the presence sensor 102a.

According to the found rule, at operation 704, the server 106 may send a play command to a music application 147a registered as a device. The play command may be written as, for example, ‘device id:Music(App)/command:play’.

At operation 705, the electronic device 100 may determine an application to receive a corresponding command based on an application type handler 181 of a mapping module 180 of FIG. 2. According to an embodiment of the disclosure, the application type handler 181 may verify (or identify) a device ID from a received play command and may determine an application (e.g., the music application 147a) to perform a command.

At operation 706, the application type handler 181 of the electronic device 100 may convert a command into application specific information and may copy the application specific information. According to an embodiment, the application type handler 181 may convert a ‘command;play’ command into a command, which may be understood by the music application 147a, for example, “intent PLAY”. The type handler 181 may send the converted command “intent_PLAY” to the music application 147a.

At operation 707, the music application 147a may perform a play operation based on a play command. In this operation, the music application 147a may reproduce recently reproduced music based on the play command to reproduce the music with reference to a specific music play list. Also, the music application 147a may output a list associated with reproducing music to the electronic device 100 or another device capable of receiving user input and may reproduce a music item selected based on a user input.

Information about a mapping table 131 of FIG. 1 operated in the mapping module 180 and the application type handler 181 may have the same values as values described with reference to FIGS. 1 and 2. Also, the device list table 203 and the event table may have the same values as values written in Tables 5 and 6.

As described above, if an external device (e.g., the presence sensor 102a) disposed in a certain position (e.g., a kitchen) detects the user, the system based on the execution of the set operation rule according to an embodiment may provide a function of reproducing music based on the music application 147a.

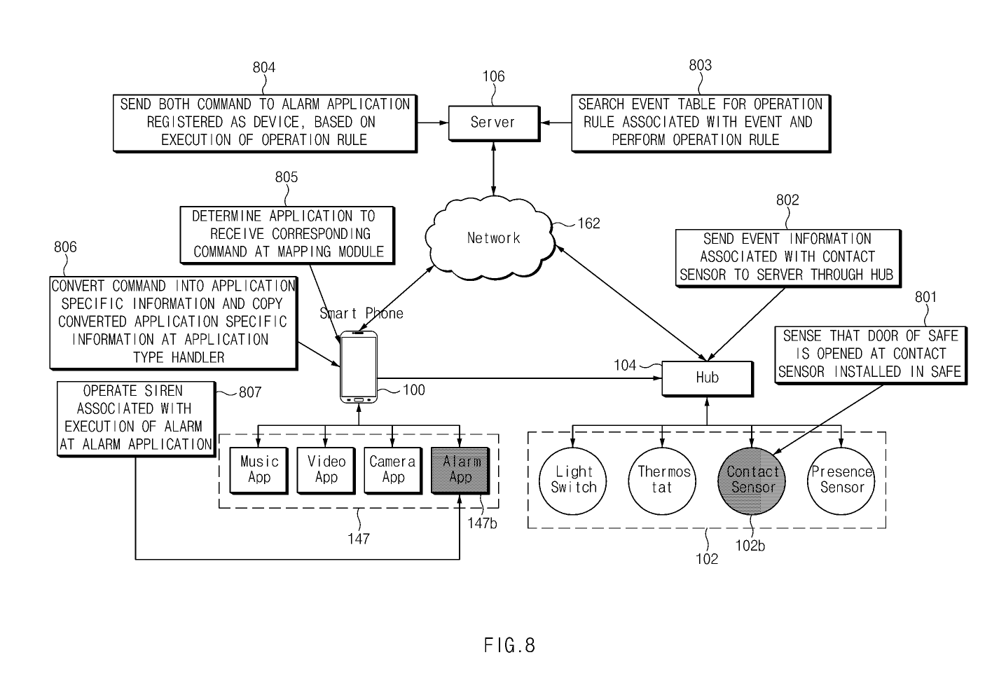

FIG. 8 is a drawing that illustrates a process of operating a system associated with executing an operation rule based on an alarm application according to an embodiment of the present disclosure.

Referring now to FIG. 8, the system associated with executing the operation rule may include an electronic device 100 (e.g., a smart phone) in which at least one application 147 is installed, a network 162, a server 106, a hub 104, and at least one external device 102.

In connection with executing the operation rule, the external device 102 (e.g., a contact sensor 102b) may be installed in a specific location, for example, a safe. Therefore, at operation 801, the contact sensor 102b may sense that a door of the safe is opened. The contact sensor 102b may send sensor information, sensed based on the opening of the door of the safe, to the hub 104.

At operation 802, the hub 104 may send event information associated with the contact sensor 102b to the server 106. The event information may be written in the form of ‘device id:Contact Sensor/event: contact(open)’.

At operation 803, the server 106 may search an event table for an operation rule associated with an event and may perform the operation rule.

At operation 804, the server 106 may send a specific command (e.g., a both command) to an alarm application 147b, registered as a device, based on the performance of the operation rule. The specific command may be written in the form of, for example, ‘device id: Alarm(App)/command: both’.

At operation 805, a mapping module 180 of the electronic device 100 may determine an application to receive the corresponding command. For example, the mapping module 180 may determine the application to receive the corresponding command as the alarm application 147b based on device ID information.

At operation 806, an application type handler 181 of the electronic device 100 may convert the command into application specific information and may copy the converted application specific information. According to an embodiment of the present disclosure, the application type handler 181 may write a command using a pseudo code. The application type handler 181 may write the command in the form of ‘function{send Intent_ALERT to alarm;OFF device.display for 10 seconds:}’ and may send the written command to the alarm application 147b.

At operation 807, the alarm application 147b may operate a siren in connection with executing the command associated with an alarm. Also, the alarm application 147b may control a display 160 of FIG. 1 to perform an operation based on performing an alarm function. For example, the alarm application 147b may turn off the display 160 based on a specific pattern.

As described above, in connection with an execution function by an operation rule, the system may arrange the contract sensor 102b in a specific place or object and the like and may execute an alarm function of the electronic device 100 based on whether there is contact.

In connection with performing the above-mentioned function, the mapping table 131 may have values in Table 7 below.

TABLE 7

| App ID | Device ID | Capability |
|---|---|---|
| alarm.app.semsung | Alarm(App) | Capability.alarm |

The application type handler 181 may have values in Table 8 below.

| | | | | |
|---|---|---|---|---|
| App ID | Attribute | Property | Command | Function |

| | | |
|---|---|---|
| alarm.app.semsung | Siren | Intent_ALERT |
| alarm.app.semsung | both | function{. . .} |

A device list table 203 of FIG. 3 may have values in Table 9 below.

| Device ID | Location | Capability | Attributes | Command |
|---|---|---|---|---|
| Alarm(App) | Smart | Capability.alarm | Alarm(off, . . .) | siren, both, |
| | Phone | | | strobe, |
| Contact | Room 1 | Capability.contactsensor | Contact(open, closed) | |
| sensor | | | | |

The event table (e.g., an event wiring table 205 of FIG. 3) may have values in Table 10 below.

| | Source | Target | | | |
|---|---|---|---|---|---|
| Event | Device ID | Device ID | Location | Capability | Action |
| Contact(open) | Contact | Alarm(App) | Smart | capa.alarm | both |
| | Sensor | | Phone | | |

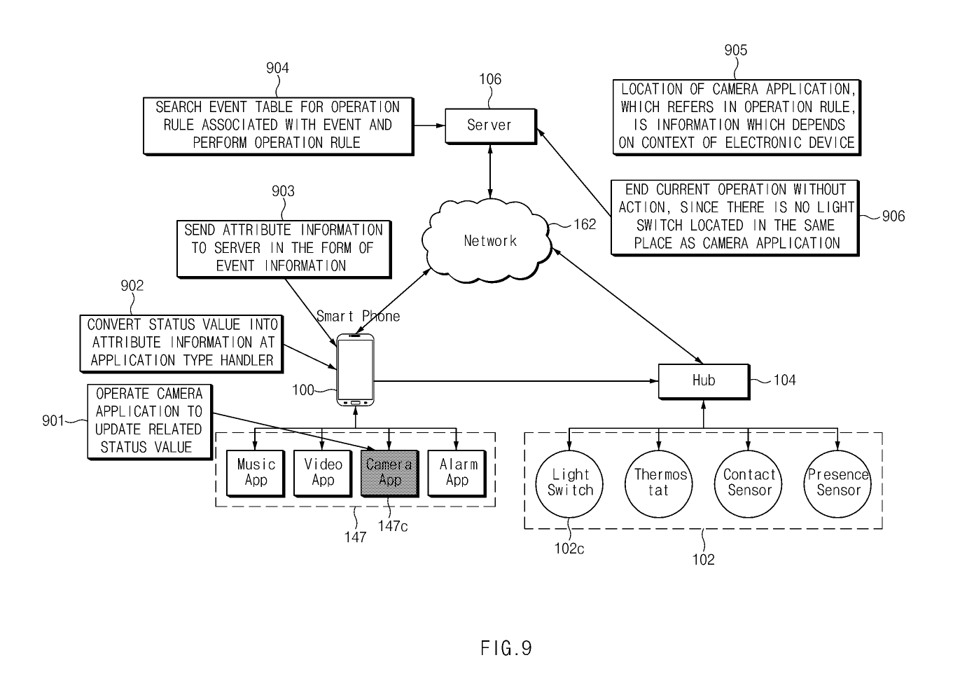

FIG. 9 is a drawing illustrating a process of operating a system associated with executing an operation rule based on a camera application according to an embodiment.

Referring now to FIG. 9, the system associated with executing the operation rule may include an electronic device (e.g., a smart phone) in which at least one application 147 is installed, a network 162, a server 106, a hub 104, and at least one external device 102.

In connection with executing the operation rule, at operation 901, a camera application 147a may operate, and a related status value may be updated. In this regard, the electronic device 100 may provide an icon or menu and the like associated with executing the camera application 147a. As the corresponding icon or menu is selected, the electronic device 100 may execute the camera application 147a.

At operation 902, an application type handler 181 of the electronic device 100 may convert a status value into attribute information based on the operation of the camera application 147a.

At operation 903, the electronic device 100 may send the attribute information to the server 106 in the form of event information. The event information may be written in the form of, for example, ‘device ID:Alarm(App)/command:both’.

At operation 904, if the server 106 receives the event information, the server 106 may search an event table for an operation rule associated with the received event information and may perform the operation rule.

At operation 905, a location of the camera application 147c to which the server 106 refers in the operation rule, may be determined by the electronic device 100. Therefore, there may be no mapped external device in connection with the camera application 147c. At operation 906, if the server 106 determines there is no light switch 102c located in the same place as the camera application 147c, the server 106 may end a current operation without an action.

In connection with performing the above-mentioned function, a mapping table 131 of FIG. 1 may have values in Table 11 below.

| App ID | Device ID | Capability |
|---|---|---|
| camera.app.semsung | Camera(App) | Capability.imagecapture |

An application type handler 181 of FIG. 2 may have values in Table 12 below.

| App ID | Attribute | Property | Command | Function |
|---|---|---|---|---|
| camera.app.semsung | status | Uri://cam/status | | |
| camera.app.semsung | | | take | Intent_EDIT |

A device list table 203 of FIG. 3 may have values in Table 13 below.

TABLE 13

| Device ID | Location | Capability | Attributes | Command |
|---|---|---|---|---|
| Camera(App) | Kitchen | Capability.imagecapture | Status(off, on) | take |
| Light Switch | Kitchen | Capability.switch | Status(off, on) | On, off |

An event table (e.g., an event wiring table 205 of FIG. 3) may have values in Table 14 below.

TABLE 14

| | Source | Target | | | |
|---|---|---|---|---|---|
| Event | Device ID | Device ID | Location | Capability | Action |
| Status(on) | Camera(App) | Light | loc.ofcamera(App) | Capability.switch | On |
| | | Switch | | | |
| loc.changed | Camera(App) | Light | loc.ofcamera(App) | Capability.switch | On |
| | | Switch | | | |

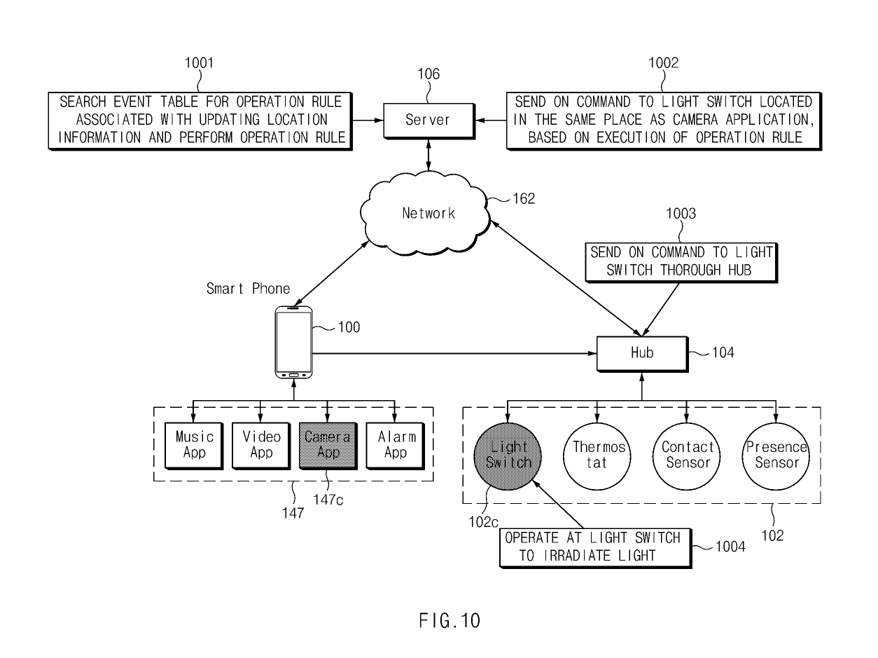

FIG. 10 is a drawing illustrating a process of operating a system associated with executing an operation rule based on a camera application according to another embodiment.

Referring now to FIG. 10, the system associated with the operation rule may include an electronic device 100 (e.g., a smart phone) in which at least one application 147 is installed, a network 162, a server 106, a hub 104, and at least one external device 102.

In connection with executing the operation rule, in operation 1001, as a user of the electronic device 100 moves to his or her kitchen, context information of the electronic device 100 may be changed. Location information of an external device (e.g., a light switch 102c) which depends on the electronic device 100 may be updated in response to the change of the context information.

At operation 1001, the server 106 may search an event table for an operation rule associated with the updating of the location information and may perform the operation rule.

At operation 1002, according to the performance of the operation rule, the server 106 may send a control command (e.g., an on command) to a light switch 102c located in the same place as a camera application 147c. The control command may be written in the form of ‘device id:Light Switch/command:on’. The server 106 may send the corresponding control command to the hub 104.

At operation 1003, the hub 104 may send the control command to the light switch 102c. At operation 1004, the light switch 102c may perform an operation based on the control command to irradiate light.

In connection with performing the above-mentioned function, a mapping table 131 of FIG. 1 may have the same values as Table 11 above. An application type handler 181 of FIG. 2 may have the same values as Table 12 above. Also, a device list table 203 of FIG. 2 may have the same values as Table 13 above. An event table (e.g., an event wiring table 205 of FIG. 3) may have the same values as Table 14 above.

According to various embodiments of the present disclosure, an electronic device may include a memory configured to store at least one application and at least one processor configured to connect to the memory. The at least one processor may be configured to register the at least one application in a device manager, which registers at least one external device, based on information about the at least one application to operate as a device and to provide a list of external devices having the same attributes as at least part of operation attributes of the at least one application.

According to various embodiments of the present disclosure, an electronic device may include a memory and at least one processor configured to operatively connect to the memory. The at least one processor may be configured to receive a request to perform (or execute) a function which may be provided from at least one application, to verify (or identify) at least one external device which may perform (or execute) the function, and to provide a list of the at least one application and the at least one external device.

According to various embodiments of the present disclosure, the at least one processor may be configured to recognize the at least one application as a device or virtual device based on the function and to register the at least one recognized application in a device manager which communicates with the at least one application.

According to various embodiments of the present disclosure, the processor may be configured to assign (or allow) a unique device identifier to the at least one application and to send information about the at least one application including the unique device identifier to the device manager.

According to various embodiments of the present disclosure, the at least one processor may be configured to output a control widow associated with controlling operation of the at least one application and a control window associated with controlling the at least one external device as one integrated user interface.

According to various embodiments of the present disclosure, the at least one processor may be configured to execute the at least one application when an event for requesting to execute the at least one application is generated and to send a control command associated with controlling an external device set to interwork with the at least one application.

According to various embodiments of the present disclosure, if receiving a control command in response to executing a specific external device, the at least one processor may be configured to verify an application to process the control command, to convert the control command into a command to be processed in the application, and to send the converted command.

According to various embodiments of the present disclosure, the at least one processor may be configured to verify whether security of the control command is valid/secure. If the security of the control command is valid/secure, the at least one processor may be configured to process the control command. If the security of the control command is invalid/insecure, the at least one processor may be configured so as not to process the control command.

According to various embodiments of the present disclosure, the processor may be configured to verify a location of the electronic device based on execution of a camera application, to generate a control command to control a light switch of a place where the electronic device is located, and to send the generated control command to the light switch.

According to various embodiments of the present disclosure, the at least one processor may be configured to verify a location of the electronic device based on execution of a music application, to generate a control command to control an external speaker of a place where the electronic device is located, and to send the generated control command to the external speaker.

According to various embodiments of the present disclosure, the at least one processor may be configured to select an audio output application to receive a control command received in response to an operation of a specific sensor and to output a specific alarm through the audio output application.

According to various embodiments of the present disclosure, the at least one processor may be configured to generate a lighting control command in response to an operation of a sleep application and to send the lighting control command to a light switch.

According to various embodiments of the present disclosure, an electronic device may include a memory and at least one processor configured to operatively connect to the memory. The at least one processor may receive a request to perform a function which may be provided from at least one application, to verify at least one external device which may perform the function, and to provide a list including the at least one application and the at least one external device.

According to various embodiments of the present disclosure, the at least one processor may register at least one application in a device manager to be recognized as a device, based on the function.

According to various embodiments of the present disclosure, the at least one processor may display a first control window for controlling the at least one application or a second control window for controlling the at least one external device in connection with the function.

According to various embodiments of the present disclosure, the at least one processor may receive an event for requesting to perform the function through the at least one application and may send a control command for performing the function to the at least one external device in response to receiving the event.

According to various embodiments of the present disclosure, the at least one external device may include a plurality of external devices. The at least one processor may send the control command to external devices paired with the at least one application among the plurality of external devices.

According to various embodiments of the present disclosure, the at least one processor does not send the control command to external devices that are not paired with the at least one application from among the plurality of external devices.

According to various embodiments of the present disclosure, the at least one processor may check security validity of the control command. If the security validity meets a specific condition, the at least one processor may send the control command (e.g., a control command to be sent to the paired external device) to the at least one application. The condition may include one or more factors. The condition may be related to the identity of the electronic device or external device. Determining the validity of the specific condition may also depend on the status of one or more sensors. Additionally, the condition may be based on the time or location of the electronic device. If the control command has a format which may be processed in the external device, the at least one processor may send the control command to the external device. If the control command has a format which may not be processed in the external device, the at least one processor may convert a format of the control command into a format which may be processed in the external device, and may send the converted command to the external device. The electronic device may include a memory configured to store information about a command format which may be processed in the external device. The at least one processor may convert a format of the control command into a command format which may be processed in the external device based on information stored in the memory.

According to various embodiments of the present disclosure, the at least one processor may verify the at least one application associated with the function, in response to receiving a control command set to perform the function in the at least one external device, to convert the control command into a command set such that the at least one application processes the function, and may send the converted command to the at least one application.

According to various embodiments of the present disclosure, the at least one processor may determine a location of the electronic device, may select a corresponding one of the at least one application and the at least one external device based on the location, and may perform the function using the corresponding one.

According to various embodiments of the present disclosure, the at least one processor may receive a request to perform another function before receiving the request to perform the function, may determine an operation association between the other function and the function, and may provide the request to perform the function if the operation association meets a specific condition.

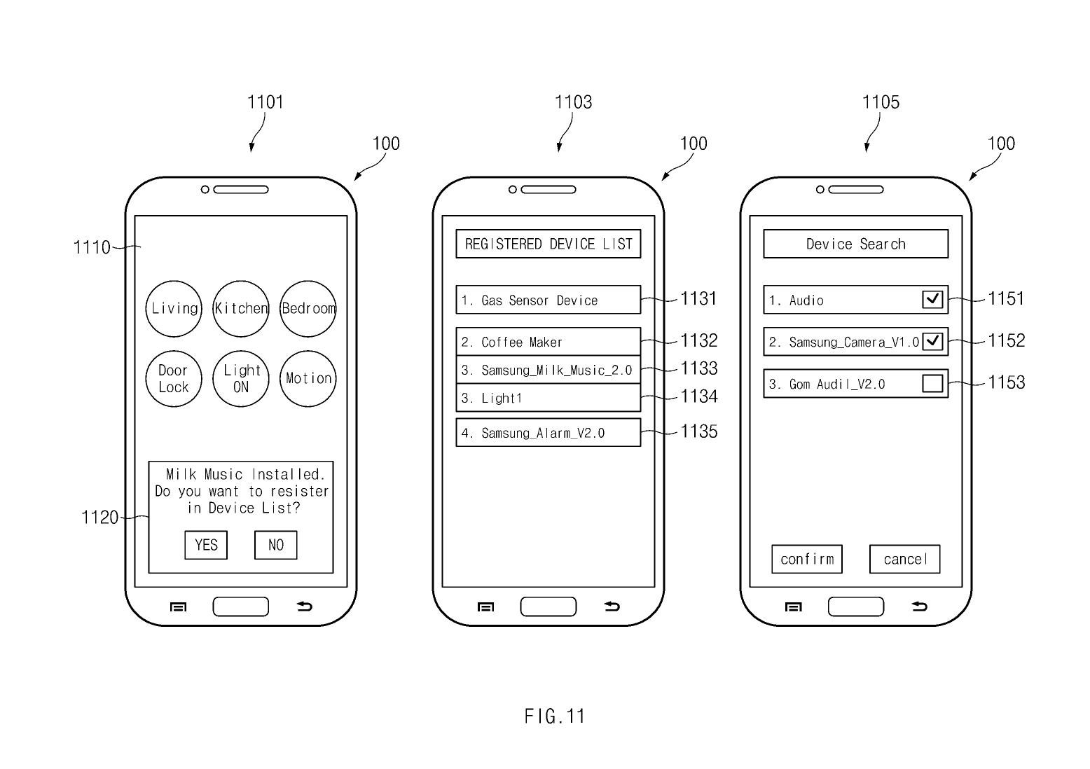

FIG. 11 is a drawing illustrating a screen interface associated with registering an application according to an embodiment of the present disclosure.

Referring now to FIG. 11, an electronic device 100 may output an application registration screen like a screen 1101 in connection with outputting the application registration screen. According to an embodiment of the present disclosure, if an application is installed in the electronic device 100, the electronic device 100 may output the application registration screen like the screen 1101. Alternatively, if an input event associated with selecting an application registered as a device is generated on an application registration screen, the electronic device 100 may output the application registration screen like the screen 1101.

The screen 1101 may include a registration icon region 1110 corresponding to applications registered as devices and a setting region 1120 associated with setting registration of applications. The registration icon region 1110 may include, for example, external device lists. In this regard, the electronic device 100 may receive an external device list from a server 106 or a hub 104 of FIG. 1. According to various embodiments of the disclosure, if a specific application to be registered as a device is selected, the electronic device 100 may send attributes information of the selected application to the server 106 or the hub 104. The electronic device 100 may receive a list of external devices which have the same attributes as attributes information sent from the server 106 or the hub 104 and may output the received list of the external devices on the registration icon region 1110. The setting region 1120 may be output in the form of, for example, a pop-up window. The setting region 1120 may be output, for example, after installation of an application is completed or when an application to be registered as a device is selected.

According to various embodiments of the present disclosure, the electronic device 100 may receive a list of devices registered in the server 106 or the hub 104 and the like and may output the received list on a screen 1103. For example, the electronic device 100 may output a list of applications registered as devices, such as a gas sensor device 1131, a coffee maker 1132, a music application 1133, a light switch 1134, and an alarm device 1135.

According to various embodiments of the present disclosure, the electronic device 100 may output a screen for searching an application, which may be registered as a device, like a screen 1105. In this regard, the electronic device 100 may provide an icon or menu for searching an application which may be registered as a device. If the corresponding icon or menu is selected, the electronic device 100 may output a list including at least one application item. If there is no application to be registered as a device, the electronic device 100 may output a screen corresponding to search failure. A screen 1105 may be a screen which outputs a result of searching applications such as an audio application 1151, a camera application 1152, and an audio player 1153. If a user of the electronic device 100 selects the audio application 1153 and the camera application 1152 and requests the electronic device 100 to register the audio application 1153 and the camera application 1152, the electronic device 100 may register the selected audio application 1153 and the selected camera application 1152. For example, the electronic device 100 may provide a unique device ID, application information, an event ID, and the like corresponding to the selected application to the server 106 or the hub 104 to request the server 106 or the hub 104 to use the selected application as a device.

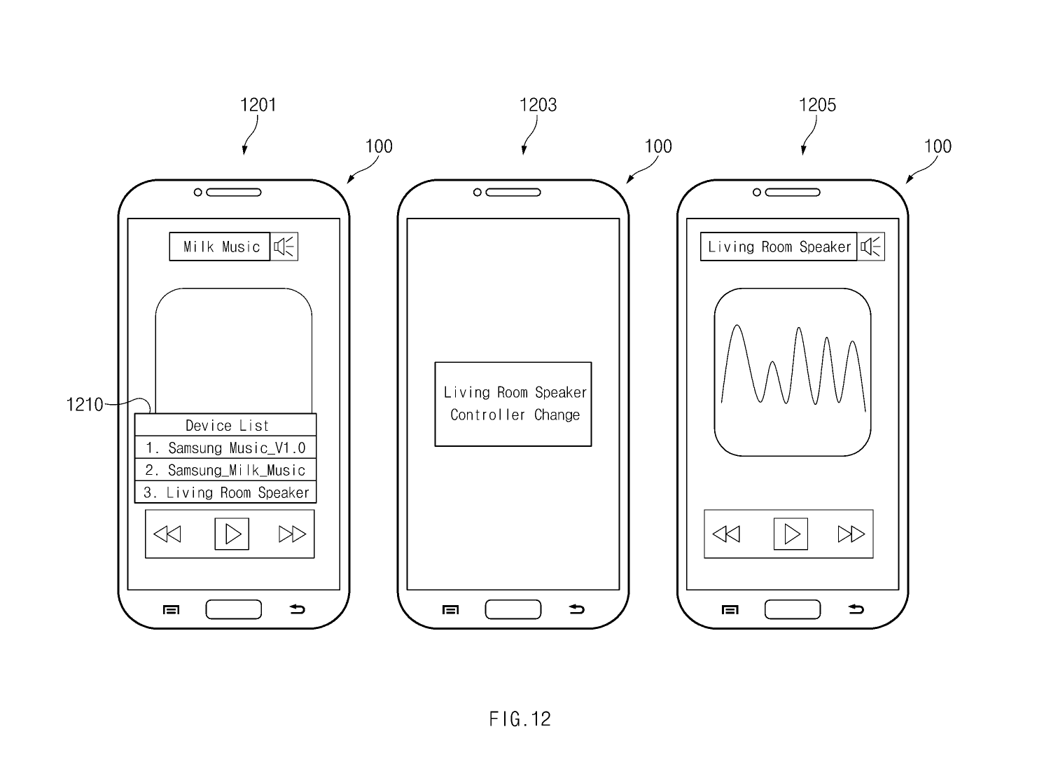

FIG. 12 is a drawing illustrating an integrated operation UI according to an embodiment of the present disclosure.

Referring now to FIG. 12, an electronic device 100 may output a music play screen like a screen 1201. In this regard, the electronic device 100 may provide a music play icon or menu and the like. If the corresponding icon or menu is selected, the electronic device 100 may output a music play screen. According to an embodiment of the present disclosure, the electronic device 100 may determine whether a music application is an application registered as a device, while outputting the music play screen. If the music application is the application registered as the device, as shown in FIG. 12, the electronic device 100 may provide a list 1210 of devices which may interwork with the music application. The device list 1210 may include items in which applications installed in external devices connected through a hub 104 of FIG. 1, the electronic device 100, or another electronic device are registered as devices in the hub 104 or a server 106 of FIG. 1.

If an external device item (e.g., 3. living room speaker) is selected in the device list 1210, the electronic device 100 may display, on a screen 1203, that the external device item is controlled by the electronic device 100. For example, the electronic device 100 may request the server 106 or the hub 104 and the like to control an external device (e.g., a living room speaker) corresponding to the external device item. The server 106 or the hub 104 and the like may provide a control right to control an external device to the electronic device 100. As the electronic device 100 obtains the control right, it may output a control screen, associated with controlling the external device, like a screen 1205. Therefore, a user of the electronic device 100 may verify a control screen of external devices, having the substantially same attributes as a specific application, through the electronic device 100 and may remotely control the corresponding external devices.

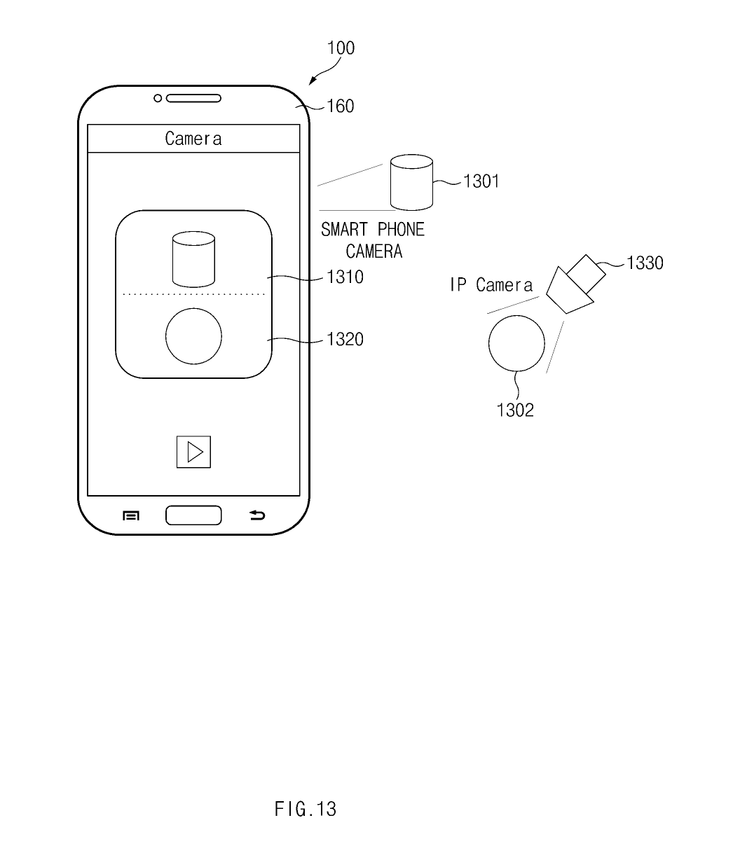

FIG. 13 is a drawing illustrating a screen interface associated with controlling operation of an application according to an embodiment of the present disclosure.

Referring now to FIG. 13, an electronic device 100 may activate a camera application based on a user input, arrival of a specific schedule, or occurrence of a specific event. The camera application may be an application registered as a device in a server 106 or a hub 104 and the like of FIG. 1. If the camera application is executed, the electronic device 100 may output a screen based on the execution of the camera application on its display 160. For example, the electronic device 100 may output an image (e.g., a preview screen or an image capturing screen), associated with a first object 1301 obtained based on execution of a camera device directly connected to the electronic device 100, on a first region 1310.

According to various embodiments of the present disclosure, the electronic device 100 may request the hub 104 and the like to control an external camera 1330 (e.g., an internet protocol (IP) camera) having the same attributes as the camera application, based on the execution of the camera application. The external camera 1330 may be a device set to an external device having the same attributes in a process of registering the camera application. The electronic device 100 may send a command to turn on the external camera 1330 to the external camera 1330 through the hub 104 based on a request to execute the camera application. The external camera 1330 may be turned on and may capture an image. The external camera 1330 may send an image (e.g., a preview image or an image capturing screen) associated with an obtained second object 1302 to the electronic device 100. The electronic device 100 may output the image provided from the external camera 1330 on a second region 1320. The electronic device 100 may provide a screen interface associated with controlling an operation of the external camera 1330. The electronic device 100 may send a command to instruct to capture an image based on the external camera 1330, a turn-off command, and the like to the external camera 1330.

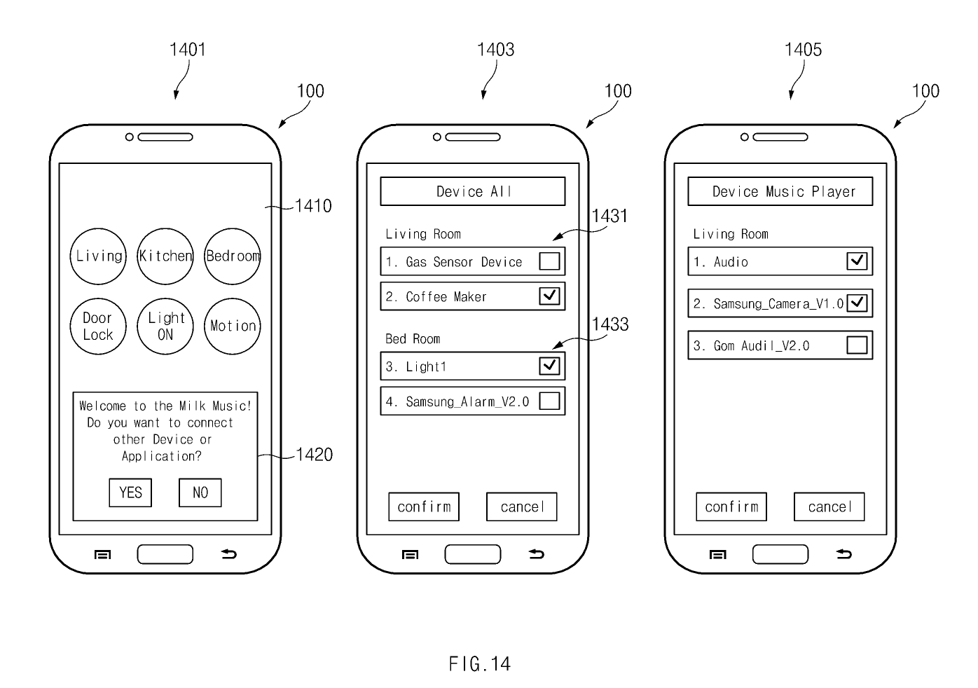

FIG. 14 is a drawing illustrating a screen interface associated with setting an operation according to an embodiment of the present disclosure.

Referring now to FIG. 14, an electronic device 100 may provide a screen interface associated with setting an operation based on a user input. According to an embodiment of the present disclosure, the electronic device 100 may provide an icon or menu associated with executing the operation setting screen interface. If the corresponding icon or menu is selected, the electronic device 100 may provide the operation setting screen interface, associated with a specific application, on a screen 1401. In this regard, the electronic device 100 may provide a list of at least one application. The at least one application may be in a state where it is registered in a hub 104 or a server 106 and the like of FIG. 1 to operate as a device. If a specific application is selected, as shown in FIG. 14, the electronic device 100 may output a verification region 1420 for verifying the setting of an operation and a list region 1410 of external devices to interwork. The external device list region 1410 may be a region which displays a list of at least one external device having the substantially same attributes as the selected application.

If a confirm input associated with setting an operation occurs, the electronic device 100 may classify and output all device items (e.g., device all), registered in the server 106 or the hub 104, for each location on a screen 1403. For example, the electronic device 100 may output items 1431 for a first group of devices which may operate in a first location (e.g., a living room) and items 1433 for a second group of devices which may operate in a second location (e.g., a bed room). If at least one of the first group of device items 1431 or the second group of device items 1433 is selected, the electronic device 100 may set an external device or application corresponding to the selected device item to interwork with an application selected on the screen 1401.

According to various embodiments of the disclosure, if a confirmed input associated with setting an operation occurs, the electronic device 100 may search devices having the same attributes as an application, an operation of which is set. The electronic device 100 may output an item of the devices having the same attributes on a screen 1405. The electronic device 100 may operate a selected item and an application selected on the screen 1401 to interwork with each other.

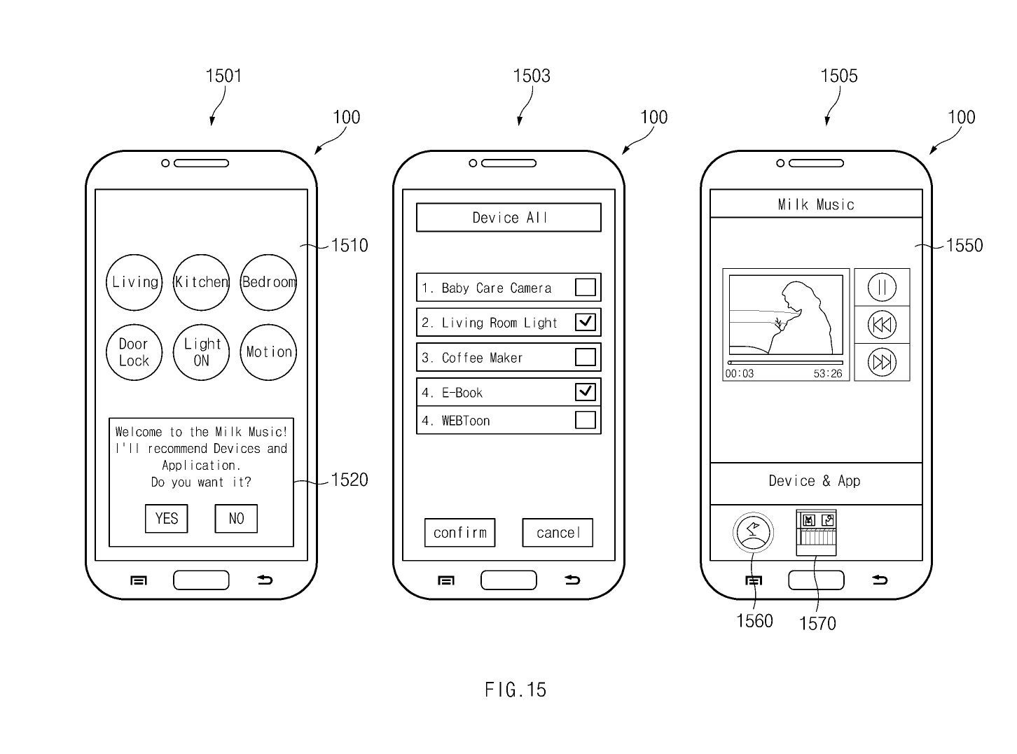

FIG. 15 is a drawing illustrating a screen interface associated with recommending operation of a device according to an embodiment of the present disclosure.

Referring now to FIG. 15, if a specific application (e.g., a music application) associated with operating a device is selected, an electronic device 100 may output a screen, based on the selection of the specific application, like a screen 1501. For example, the electronic device 100 may output an item display region 1510 for displaying items of external devices registered in a hub 104 and the like of FIG. 1 and a setting region 1520 associated with operating the selected specific application. The setting region 1520 may include, for example, offering a recommendation function which may be provided from the electronic device 100 in connection with the selected application.

If an input for requesting to operate a device based on the recommendation function is received, the electronic device 100 may output a screen, including a recommendation device or application item, like a screen 1503. Applications (e.g., an e-book, a webtoon, and the like) displayed on the screen 1503 may be applications registered as devices in the hub 104 or a server 106 and the like to be the same as external devices and the like. The electronic device 100 may recommend at least one of external devices or applications based on history performed by interworking with a specific application or a specific external device, or an application. Alternatively, the electronic device 100 may receive recommendation information from the server 106 and the like and may recommend external device or application items when a specific application (e.g., a music application) is selected based on the received recommendation information.

If a living room light switch item (e.g., 2. living room light) and an e-book application item (e.g., 4. e-book) are selected on the screen 1503, the electronic device 100 may output a screen interface associated with operating each device on a screen 1505. For example, the electronic device 100 may output a control screen region 1550 associated with controlling the operation of the music application, a lighting control icon 1560 associated with controlling the operation of a living room light switch, and an e-book control icon 1570 based on selection of an e-book application item. When the lighting control icon 1560 is selected, the electronic device 100 may output a screen interface (e.g., for turning on lighting, turning off the lighting, and adjusting brightness of the lighting) associated with controlling the lighting as a pop-up window or a new window. When the e-book control icon 1570 is selected, the electronic device 100 may output at least one e-book list stored in the electronic device 100. Alternatively, the electronic device 100 may output an e-book list which may be received from the server 106 and the like.

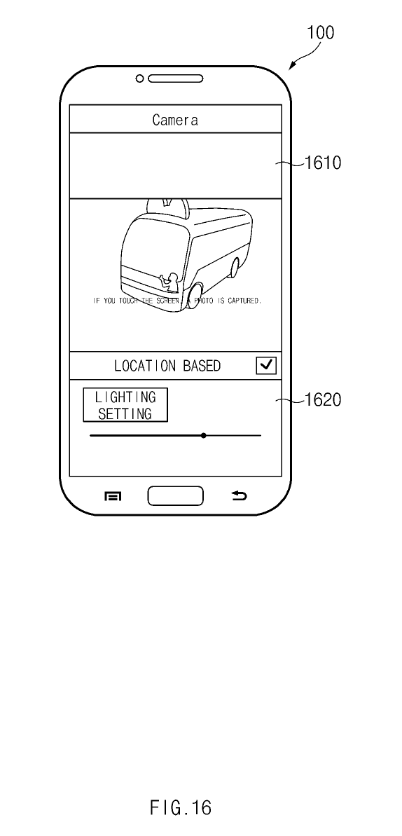

FIG. 16 is a drawing that illustrates a screen interface associated with operating interworking of a camera function according to an embodiment of the present disclosure.

Referring now to FIG. 16, an electronic device 100 may output a camera region 1610 associated with operating a camera application and a lighting region 1620 associated with operating a light switch. The camera region 1610 may be a region which outputs an image obtained based on a camera device included in the electronic device 100. Alternatively, the camera region 1610 may be a region which outputs an image obtained by an external camera having the substantially same attributes as the camera application of the electronic device 100.

The lighting region 1620 may be a control region for controlling a light switch set to operate together when the camera application is executed. According to an embodiment of the present disclosure, the light switch may be a device set to interwork and operate when the camera application is executed.

According to various embodiments of the present disclosure, if an input for requesting to executing the camera application occurs, the electronic device 100 may send location information to a hub 104 or a server 106 of FIG. 1. Also, the electronic device 100 may send application information to the hub 104 or the server 106. The hub 104 or the server 106 may support the control of a light switch, where the electronic device 100 is located, based on location information of the electronic device 100. According to an embodiment of the disclosure, if an input associated with adjusting a lighting level of the lighting region 1620 is received, the electronic device 100 may send a lighting control command corresponding to the corresponding input to the hub 104 or the server 106. The hub 104 or the server 106 may convert the received lighting control command into a command which may be understood by the light switch and may send the converted command to the light switch of a point where the electronic device 100 is located. In connection with detecting a location of the electronic device 100, a system may operate a presence sensor.

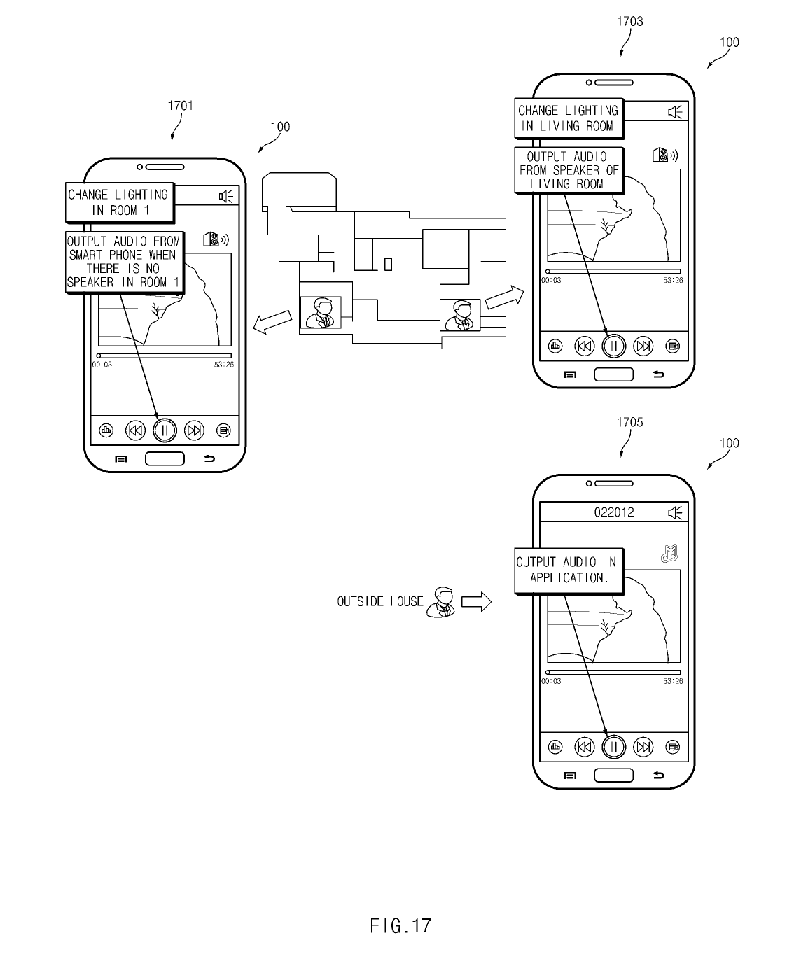

FIG. 17 is a drawing illustrating a process of operating a device based on a user location according to an embodiment of the disclosure.

Referring now to FIG. 17, according to an embodiment of the disclosure, if an electronic device 100 is located at a first location (e.g., a room 1), the electronic device may execute a music application on a screen 1701 based on a specific setting. In this regard, a hub 104 or a server 106 of FIG. 1 may collect a location of the electronic device 100 based on a presence sensor or an access point the electronic device 100 accesses. If the electronic device 100 is arranged on a specific point, the hub 104 or the server 106 and the like may control an operation of a specific external device (e.g., a light switch). The hub 104 or the server 106 and the like may control the electronic device 100 to execute an application (e.g., a music application) having the substantially same attributes as an external device, together with controlling an operation of the external device. For example, the hub 104 or the server 106 and the like may send a control command associated with executing the music application to the music application of the electronic device 100, and control a light switch.

The hub 104 or the server 106 may generate a control command in a different way based on a state of a specific location (e.g., a type of an external device arranged on a corresponding point). For example, there is no external speaker in a specific location, the hub 104 or the server 106 may request the electronic device 100 to execute the music application of the electronic device 100 and to output audio. If there is an external speaker in the specific location, the hub 104 or the server 106 may send a command to request the electronic device 100 to execute the music application and a command to request the electronic device 100 to output audio data generated based on execution of an application to an external speaker to the electronic device 100.

According to various embodiments of the present disclosure, if the electronic device 100 is located on a second location (e.g., a living room), the hub 104 or the server 106 may detect a location of the electronic device 100 (or a user of the electronic device 100) using a specific external device (e.g., a presence sensor and the like). The hub 104 or the server 106 may send a control command, for adjusting a light switch which is present at the second location, to a living room light switch. For example, the hub 104 or the server 106 may send a control command to the living room light switch such that the living room light switch is turned on and irradiates light with specific brightness. Also, the hub 104 or the server 106 may generate a control command associated with executing a music application (registered as a device) and may provide the generated control command to the music application. The hub 104 or the server 106 may detect that an external speaker is present in a location where the electronic device 100 is located, may send a control command associated with outputting audio data to the electronic device 100, and may send an audio output control command (e.g., a turn-on and volume adjustment command) to the external speaker. The external speaker may output audio data, received from the hub 104 or the server 106, with a volume of a specific level.

According to various embodiments of the present disclosure, if the electronic device 100 is located in a third location (e.g., outside the house), the hub 104 or the server 106 may detect a location of the electronic device 100 (or the user) using a specific external device (e.g., an access point, a presence sensor, and the like). The hub 104 or the server 106 may send a control command, associated with controlling a function of the electronic device 100 which is present in the third location, to the electronic device 100. For example, the hub 104 or the server 106 may send a control command, associated with reproducing music, to the electronic device 100. If there is no separate external device, the hub 104 or the server 106 may provide only a control command, associated with controlling the electronic device 100, to the electronic device 100.

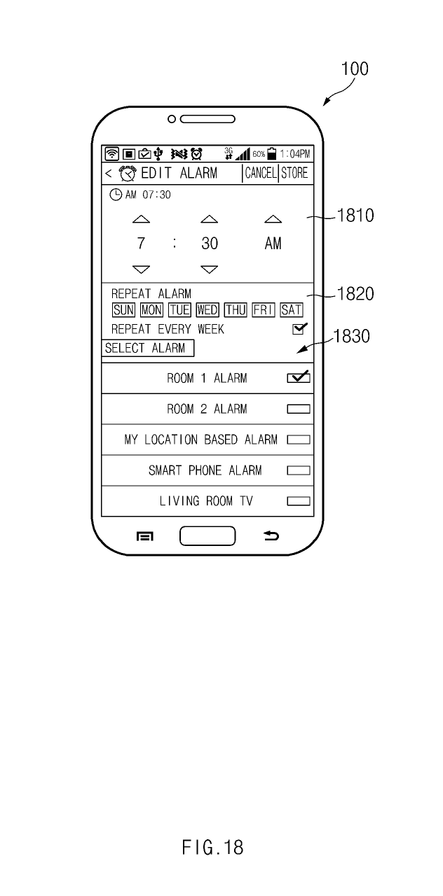

FIG. 18 is a drawing illustrating a screen interface associated with setting an alarm application according to an embodiment of the present disclosure.

Referring now to FIG. 18, an electronic device 100 may register an alarm application in a hub 104 or a server 106 and the like of FIG. 1 to operate like a device such as an external device. In this process, the electronic device 100 may assign a unique device ID and an event ID to the alarm application and may provide information (e.g., a device ID, an event ID, and the like) about the alarm application to the hub 104 or the server 106. If an input associated with setting the alarm application occurs, as shown in FIG. 18, the electronic device 100 may output an alarm editing screen. The alarm editing screen may include, for example, a time setting region 1810, a repetition setting region 1820, and an external device setting region 1830. The time setting region 1810 may be a region for setting information about a time when an alarm is executed. The repetition setting region 1820 may be a region for setting whether an alarm is repeated every day. The external device setting region 1830 may be a region for setting an external device to output an alarm when an alarm function is executed.

In connection with outputting the external device setting region 1830, if the electronic device 100 receives a request to set the alarm application, the electronic device 100 may request a list of external devices having the substantially same attributes (e.g., audio output attributes) as the alarm application from the hub 104 and the like. If a plurality of items are selected on the external device setting region 1830, the electronic device 100 may send a control command, associated with outputting an audio when an alarm of the alarm application is executed, to the alarm application. According to various embodiments, the electronic device 100 may provide external device setting information to the hub 104 or the server 106 and may provide a control command to the hub 104 when an alarm function is executed. Therefore, the hub 104 may send the control command to a plurality of external devices.

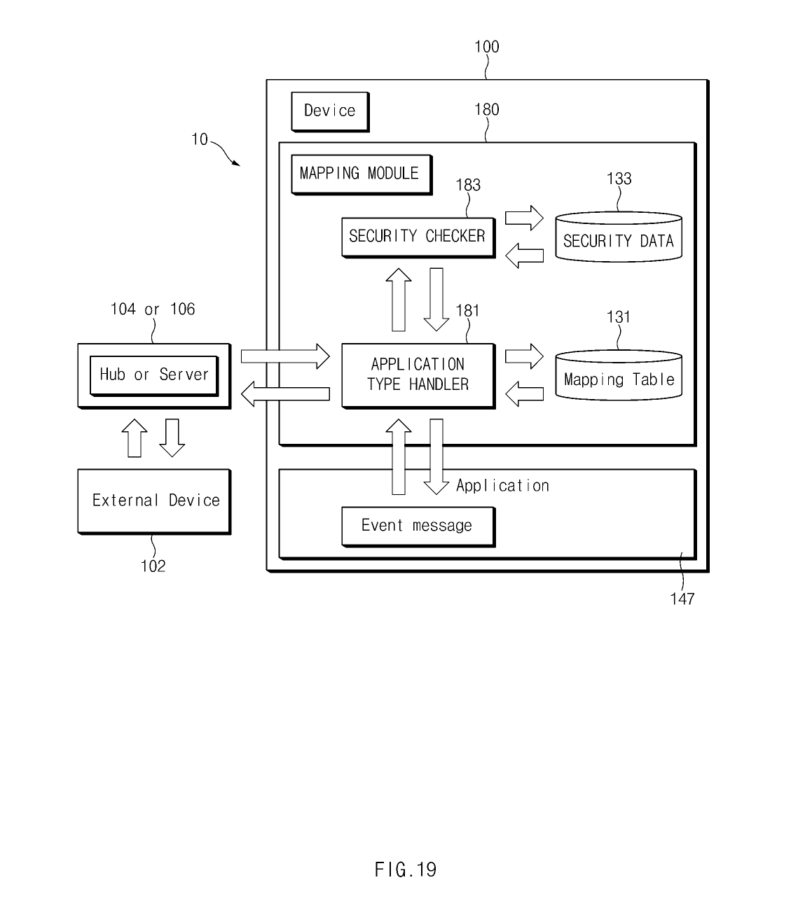

FIG. 19 is a block diagram schematically illustrating a configuration of an interworking system according to an embodiment of the present disclosure.

Referring now to FIG. 19, an interworking system 10 may include an electronic device 100, a hub 104 or a server 106, and an external device 102. The hub 104 or the server 106 may connect with the electronic device 100 based on at least one of a network 162 of FIG. 1, a local-area wireless communication channel, or a wired communication channel. The hub 104 or the server 106 may support to interface at least one application from the electronic device 100 like the similar external devices. As described above, the external device 102 may be an IoT device, communicatively connecting to the hub 104 or the server 106 and the like, and operating based on a control command provided from the hub 104 or the server 106. This external device 102 may include, for example, a variety of electronic devices which may be arranged in a house or office and the like.

The electronic device 100 may include, for example, a mapping module 180. As shown in FIG. 19, the mapping module 180 may include a security checker 183 and an application type handler 181 and may store security data 133 and a mapping table 131. The electronic device 100 may include at least one application 147. The application type handler 181 may communicate with the hub 104 or the server 106 and may perform signal processing to operate the at least one application 147 as at least one device. For example, the application type handler 181 may receive a control command associated with controlling the at least one application 147 and may send the received control command to the at least one application 147. The application type handler 181 may refer to the mapping table 131 associated with processing the control command. If the application type handler 181 receives the control command, the application type handler 181 may write an event message associated with processing the corresponding control command and may send the written event message to the at least one application 147. Also, the application type handler 181 may convert an event message generated by the application 147 into a specific control command. According to an embodiment of the present disclosure, the application type handler 181 may generate a specific control command (e.g., a command to control an external device having the substantially same attributes as the application 147) based on operation of the application area 147 and may provide the generated control command to the hub 104 or the server 106 and the like.

The security checker 183 may verify security validity of a processed signal, while monitoring signal processing of the application type handler 181. The security checker 183 prevent an insecure signal from being processed. In this regard, the security checker 183 may refer to the security data 133 in which a security policy and the like are set.

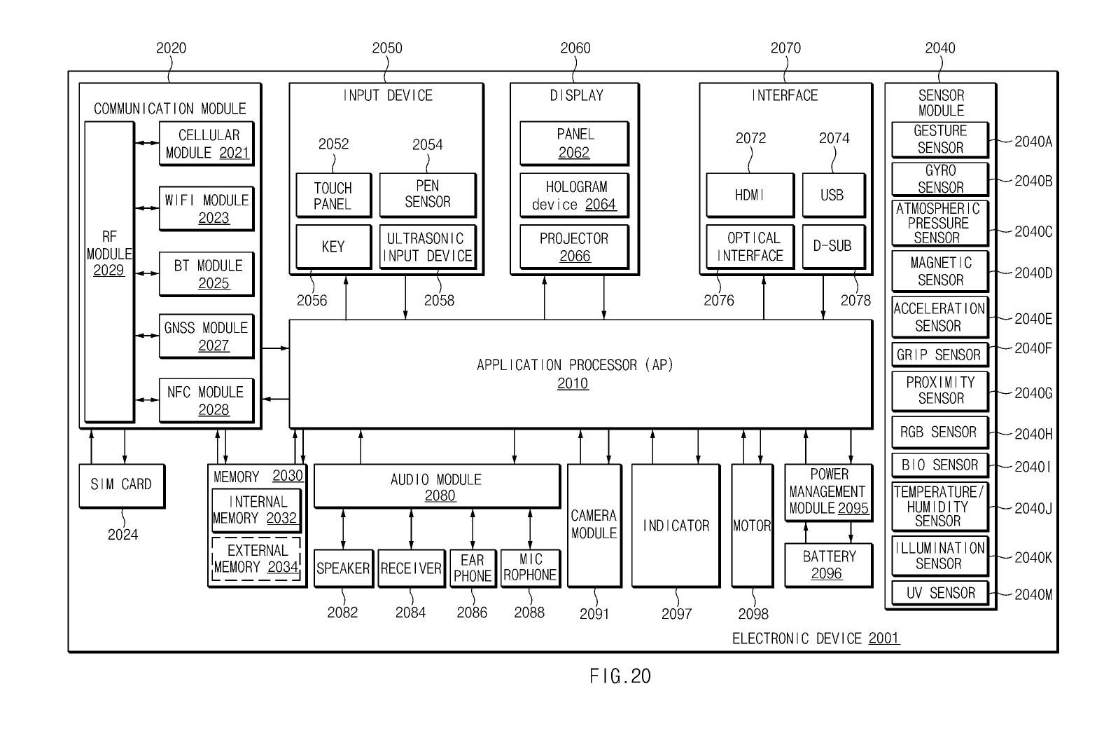

FIG. 20 is a block diagram illustrating a configuration of an electronic device according to an embodiment of the present disclosure.

Referring now to FIG. 20, an electronic device 2001 may include, for example, all or part of an electronic device described in the various embodiments described above. The electronic device 2001 may include at least one processor 2010 (e.g., an application processor (AP)), a communication module 2020, a subscriber identification module (SIM) 2024, a memory 2030, a sensor module 2040, an input device 2050, a display 2060, an interface 2070, an audio module 2080, a camera module 2091, a power management module 2095, a battery 2096, an indicator 2097, and a motor 2098.

The processor 2010 may drive, for example, an operating system (OS) or an application program to control a plurality of hardware or software components connected thereto and may process and compute a variety of data. The processor 2010 may be implemented with, for example, a system on chip (SoC). According to an embodiment, the processor 2010 may include a graphic processing unit (GPU) (not shown) and/or an image signal processor (not shown). The processor 2010 may include at least some (e.g., a cellular module 2021) of the components shown in FIG. 20. The processor 2010 may load instructions or data received from at least one of other components (e.g., a non-volatile memory) into a volatile memory to process the data and may store various data in a non-volatile memory.

The communication module 2020 includes hardware to receive, transmit, or transceive wirelessly, may have the same or similar configuration to a communication interface 170 of FIG. 1. The communication module 2020 may include, for example, the cellular module 2021, a wireless-fidelity (Wi-Fi) module 2023, a Bluetooth (BT) module 2025, a global navigation satellite system (GNSS) module 2027 (e.g., a GPS module, a Glonass module, a Beidou module, or a Galileo module), a near field communication (NFC) module 2028, and a radio frequency (RF) module 2029. Additionally, the communication module 2020 may further include a magnetic secure transmission (MST) module (not shown), and one or more antennas for various wireless frequencies.

The cellular module 2021 may provide, for example, a voice call service, a video call service, a text message service, or an Internet service, and the like through a communication network. According to an embodiment of the present disclosure, the cellular module 2021 may identify and authenticate the electronic device 2001 in a communication network using a SIM 2024 (e.g., a SIM card). According to an embodiment of the present disclosure, the cellular module 2021 may perform at least part of functions which may be provided by the processor 2010. According to an embodiment of the present disclosure, the cellular module 2021 may include a communication processor (CP).

The Wi-Fi module 2023, the BT module 2025, the GNSS module 2027, or the NFC module 2028 may include, for example, a processor for processing data transmitted and received through the corresponding module. According to various embodiments, at least some (e.g., two or more) of the cellular module 2021, the Wi-Fi module 2023, the BT module 2025, the GNSS module 2027, or the NFC module 2028 may be included in one integrated chip (IC) or one IC package.

The RF module 2029 may transmit and receive, for example, a communication signal (e.g., an RF signal). Though not shown, the RF module 2029 may include, for example, a transceiver, a power amplifier module (PAM), a frequency filter, or a low noise amplifier (LNA), or an antenna, and the like. According to another embodiment of the present disclosure, at least one of the cellular module 2021, the Wi-Fi module 2023, the BT module 2025, the GNSS module 2027, or the NFC module 2028 may transmit and receive an RF signal through a separate RF module.

The SIM 2024 may include, for example, a card which includes a SIM and/or an embedded SIM. The SIM 2024 may include unique identification information (e.g., an integrated circuit card identifier (ICCID)) or subscriber information (e.g., an international mobile subscriber identity (IMSI)).

The non-transitory memory 2030 (e.g., a memory 130 of FIG. 1) may include, for example, an embedded memory 2032 or an external memory 2034. The embedded memory 2032 may include at least one of, for example, a volatile memory (e.g., a dynamic random access memory (DRAM), a static RAM (SRAM), a synchronous dynamic RAM (SDRAM), and the like), or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory, and the like), a hard drive, or a solid state drive (SSD)).

The external memory 2034 may include a flash drive, for example, a compact flash (CF), a secure digital (SD), a micro-SD, a mini-SD, an extreme digital (xD), a multimedia car (MMC), or a memory stick, and the like. The external memory 2034 may operatively and/or physically connect with the electronic device 2001 through various interfaces.

The electronic device 2001 may further include a secure module (not shown). The secure module may be a module which has a relatively higher secure level than the memory 2030 and may be a circuit which stores secure data and guarantees a protected execution environment. The secure module may be implemented with a separate circuit and may include a separate processor. The secure module may include, for example, an embedded secure element (eSE) which is present in a removable smart chip or a removable SD card or is embedded in a fixed chip of the electronic device 2001. Also, the secure module may be driven by an OS different from the OS of the electronic device 2001. For example, the secure module may operate based on a Java card open platform (JCOP) OS.

The sensor module 2040 may measure, for example, a physical quantity or may detect an operation state of the electronic device 2001, and may convert the measured or detected information to an electric signal. The sensor module 2040 may include at least one of, for example, a gesture sensor 2040A, a gyro sensor 2040B, a barometric pressure sensor 2040C, a magnetic sensor 2040D, an acceleration sensor 2040E, a grip sensor 2040F, a proximity sensor 2040G, a color sensor 2040H (e.g., red, green, blue (RGB) sensor), a biometric sensor 2040I, a temperature/humidity sensor 2040J, an illumination sensor 2040K, or an ultraviolet (UV) sensor 2040M. Additionally or alternatively, the sensor module 2040 may further include, for example, an e-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris sensor (not shown), and/or a fingerprint sensor (not shown), and the like. The sensor module 2040 may further include a control circuit for controlling at least one or more sensors included therein. According to various embodiments, the electronic device 2001 may further include a processor configured to control the sensor module 2040, as part of the processor 2010 or to be independent of the processor 2010. While the processor 2010 is in a sleep state, the electronic device 2001 may control the sensor module 2040.

The input device 2050 may include, for example, a touch panel 2052, a (digital) pen sensor 2054, a key 2056, or an ultrasonic input unit 2058. The touch panel 2052 may use at least one of, for example, a capacitive type, a resistive type, an infrared type, or an ultrasonic type. Also, the touch panel 2052 may further include a control circuit. The touch panel 2052 may further include a tactile layer and may provide a tactile reaction to a user.

The (digital) pen sensor 2054 may be, for example, part of the touch panel 2052 or may include a separate sheet for recognition. The key 2056 may include, for example, a physical button, an optical key, or a keypad. The ultrasonic input unit 2058 may allow the electronic device 2001 to detect a sound wave using a microphone (e.g., a microphone 2088) and to verify data through an input tool generating an ultrasonic signal.

The display 2060 (e.g., a display 160 of FIG. 1) may include a panel 2062, a hologram device 2064, or a projector 2066. The panel 2062 may include the same or similar configuration to the display 160. The panel 2062 may be implemented to be, for example, flexible, transparent, or wearable. The panel 2062 and the touch panel 2052 may be integrated into one module. The hologram device 2064 may show a stereoscopic image in a space using interference of light. The projector 2066 may project light onto a screen to display an image. The screen may be positioned, for example, inside or outside the electronic device 2001. According to an embodiment, the display 2060 may further include a control circuit for controlling the panel 2062, the hologram device 2064, or the projector 2066.

The interface 2070 may include, for example, a high-definition multimedia interface (HDMI) 2072, a universal serial bus (USB) 2074, an optical interface 2076, or a D-subminiature 2078. The interface 2070 may be included in, for example, a communication interface 170 shown in FIG. 1. Additionally or alternatively, the interface 2070 may include, for example, a mobile high definition link (MHL) interface, an SD card/multimedia card (MMC) interface, or an infrared data association (IrDA) standard interface.

The audio module 2080 may convert a sound and an electric signal in dual directions. At least part of components of the audio module 2080 may be included in, for example, an input and output interface 150 shown in FIG. 1. The audio module 2080 may include an integrated circuit to process sound information input or output through, for example, a speaker 2082, a receiver 2084, an earphone 2086, or the microphone 2088, and the like.

The camera module 2091 may be a device which captures a still image and a moving image. According to an embodiment of the present disclosure, the camera module 2091 may include one or more image sensors (not shown) (e.g., a front sensor or a rear sensor), a lens (not shown), an image signal processor (ISP) (not shown), or a flash (not shown) (e.g., an LED or a xenon lamp).

The power management module 2095 may manage, for example, power of the electronic device 2001. According to an embodiment of the present disclosure, though not shown, the power management module 2095 may include a power management integrated circuit (PMIC), a charger IC or a battery or fuel gauge. The PMIC may have a wired charging method and/or a wireless charging method. The wireless charging method may include, for example, a magnetic resonance method, a magnetic induction method, or an electromagnetic method, and the like. An additional circuit for wireless charging, for example, a coil loop, a resonance circuit, or a rectifier, and the like may be further provided. The battery gauge may measure, for example, the remaining capacity of the battery 2096 and voltage, current, or temperature thereof while the battery 2096 is charged. The battery 2096 may include, for example, a rechargeable battery or a solar battery.

The indicator 2097 may display a specific state of the electronic device 2001 or part (e.g., the processor 2010) thereof, for example, a booting state, a message state, or a charging state, and the like. The motor 2098 may convert an electric signal into mechanical vibration and may generate vibration or a haptic effect, and the like. Though not shown, the electronic device 801 may include a processing unit (e.g., a GPU) for supporting a mobile TV. The processing unit for supporting the mobile TV may process media data according to standards, for example, a digital multimedia broadcasting (DMB) standard, a digital video broadcasting (DVB) standard, or a mediaFlo™ standard, and the like.

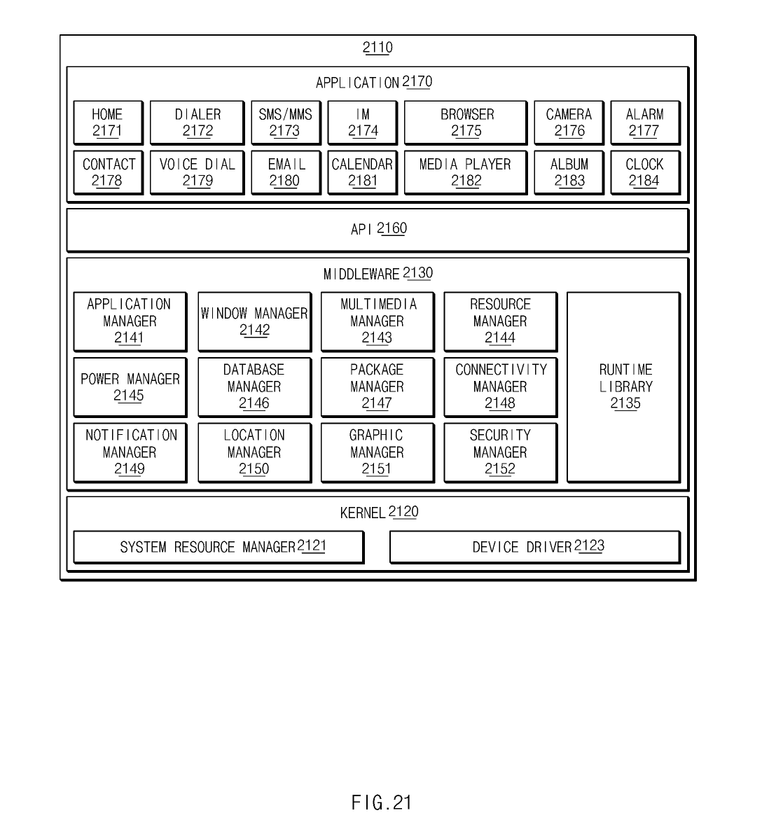

FIG. 21 is a block diagram illustrating a configuration of a program module based on an embodiment of the present disclosure. It is to be understood that none of the appended claims are directed to pure software and a program module is loaded in to hardware for execution.

Referring now to FIG. 21, according to various embodiments, a program module 2110 (e.g., a program 140 of FIG. 1) may include an operating system (OS) for controlling resources associated with an electronic device (e.g., an electronic device 100 of FIG. 1) and/or various applications (e.g., an application program 147 of FIG. 1) which are executed on the OS. The OS may be, for example, Android, iOS, Windows, Symbian, Tizen, or Bada, and the like.

The program module 2110 may include a kernel 2120, a middleware 2130, an application programming interface (API) 2160, and/or an application 2170. At least part of the program module 2110 may be preloaded on the electronic device, or may be downloaded from an external electronic device (e.g., a hub 104, a server 106, and the like).

The kernel 2120 (e.g., a kernel 141 of FIG. 1) may include, for example, a system resource manager 2121 and/or a device driver 2123. The system resource manager 2121 may control, assign, or collect, and the like system resources. According to an embodiment, the system resource manager 2121 may include a process management unit, a memory management unit, or a file system management unit, and the like. The device driver 2123 may include, for example, a display driver, a camera driver, a Bluetooth (BT) driver, a shared memory driver, a universal serial bus (USB) driver, a keypad driver, a wireless-fidelity (Wi-Fi) driver, an audio driver, or an inter-process communication (IPC) driver.

The middleware 2130 (e.g., a middleware 143 of FIG. 1) may provide, for example, functions the application 2170 needs in common, and may provide various functions to the application 2170 through the API 2160 such that the application 2170 efficiently uses limited system resources in the electronic device. According to an embodiment, the middleware 2130 (e.g., the middleware 143) may include at least one of a runtime library 2135, an application manager 2141, a window manager 2142, a multimedia manager 2143, a resource manager 2144, a power manager 2145, a database manager 2146, a package manager 2147, a connectivity manager 2148, a notification manager 2149, a location manager 2150, a graphic manager 2151, a security manager 2152, or a payment manager (not shown).

The runtime library 2135 may include, for example, a library module used by a compiler to add a new function through a programming language while the application 2170 is executed. The runtime library 2135 may perform a function about input and output management, memory management, or an arithmetic function.

The application manager 2141 may manage, for example, a life cycle of at least one of the application 2170. The window manager 2142 may manage graphic user interface (GUI) resources used on a screen of the electronic device. The multimedia manager 2143 may ascertain a format necessary for reproducing various media files and may encode or decode a media file using a codec corresponding to the corresponding format. The resource manager 2144 may manage source codes of at least one of the application 2170, and may manage resources of a memory or a storage space, and the like.

The power manager 2145 may act together with, for example, a basic input/output system (BIOS) and the like, may manage a battery or a power source, and may provide power information necessary for an operation of the electronic device. The database manager 2146 may generate, search, or change a database to be used in at least one of the application 2170. The package manager 2147 may manage installation or update of an application distributed by a type of a package file.

The connectivity manager 2148 may manage, for example, wireless connection such as Wi-Fi connection or BT connection, and the like. The notification manager 2149 may display or notify events, such as an arrival message, an appointment, and proximity notification, by a method which is not disturbed to the user. The location manager 2150 may manage location information of the electronic device. The graphic manager 2151 may manage a graphic effect to be provided to the user or a user interface (UI) related to the graphic effect. The security manager 2152 may provide all security functions necessary for system security or user authentication, and the like. According to an embodiment of the present disclosure, when the electronic device (e.g., the electronic device 100) has a phone function, the middleware 2130 may further include a telephony manager (not shown) for managing a voice or video communication function of the electronic device. The payment manager may relay information for payment from the application 2170 to the application 2170 or the kernel 2120. Also, the payment manager may send information, associated with payment, received from the external device in the electronic device or may send information stored in the electronic device to the external device.

The middleware 2130 may include a middleware module which configures combinations of various functions of the above-described components. The middleware 2130 may provide a module which specializes according to kinds of OSs to provide a differentiated function. Also, the middleware 2130 may dynamically delete some of old components or may add new components.

The API 2160 (e.g., an API 145 of FIG. 1) may be, for example, a set of API programming functions, and may be provided with different components according to OSs. For example, in case of Android or iOS, one API set may be provided according to platforms. In case of Tizen, two or more API sets may be provided according to platforms.

The application 2170 (e.g., an application program 147 of FIG. 1) may include one or more of, for example, a home application 2171, a dialer application 2172, a short message service/multimedia message service (SMS/MMS) application 2173, an instant message (IM) application 2174, a browser application 2175, a camera application 2176, an alarm application 2177, a contact application 2178, a voice dial application 2179, an e-mail application 2180, a calendar application 2181, a media player application 2182, an album application 2183, a clock application 2184, a payment application (not shown), a health care application (e.g., an application for measuring quantity of exercise or blood sugar, and the like), or an environment information application (e.g., an application for providing atmospheric pressure information, humidity information, or temperature information, and the like), and the like.

According to an embodiment of the present disclosure, the application 2170 may include an application (hereinafter, for better understanding and ease of description, referred to as “information exchange application”) for exchanging information between the electronic device (e.g., the electronic device 100) and the server 106 (e.g., the hub 104). The information exchange application may include, for example, a notification relay application for transmitting specific information to the external electronic device or a device management application for managing the external electronic device.

For example, the notification relay application may include a function of transmitting notification information, which is generated by other applications (e.g., the SMS/MMS application, the e-mail application, the health care application, or the environment information application, and the like) of the electronic device, to the external electronic device (e.g., an external device 102 of FIG. 1). Also, the notification relay application may receive, for example, notification information from the external electronic device, and may provide the received notification information to the user of the electronic device.

The device management application may manage (e.g., install, delete, or update), for example, at least one (e.g., a function of turning on/off the external device itself (or partial components) or a function of adjusting brightness (or resolution) of a display) of functions of the external device 102 which communicates with the electronic device, an application which operates in the external electronic device, or a service (e.g., a call service or a message service) provided from the external device 102.

According to an embodiment of the present disclosure, the application 2170 may include an application (e.g., the health card application of a mobile medical device) which is preset based on attributes of the external device 102. According to an embodiment, the application 2170 may include an application received from the external device 102, the server 106, or the hub 104. According to an embodiment, the application 2170 may include a preloaded application or a third party application which may be downloaded from the server 106. Names of the components of the program module 2110 according to various embodiments of the present disclosure may differ according to kinds of OSs.

According to various embodiments of the present disclosure, at least part of the program module 2110 may be implemented with software, firmware, hardware, or at least two or more combinations thereof. At least part of the program module 2110 may be implemented (e.g., executed) by, for example, a processor (e.g., a processor 120 of FIG. 1). At least part of the program module 2110 may include, for example, a module, a program, a routine, sets of instructions, or a process, and the like for performing one or more functions.

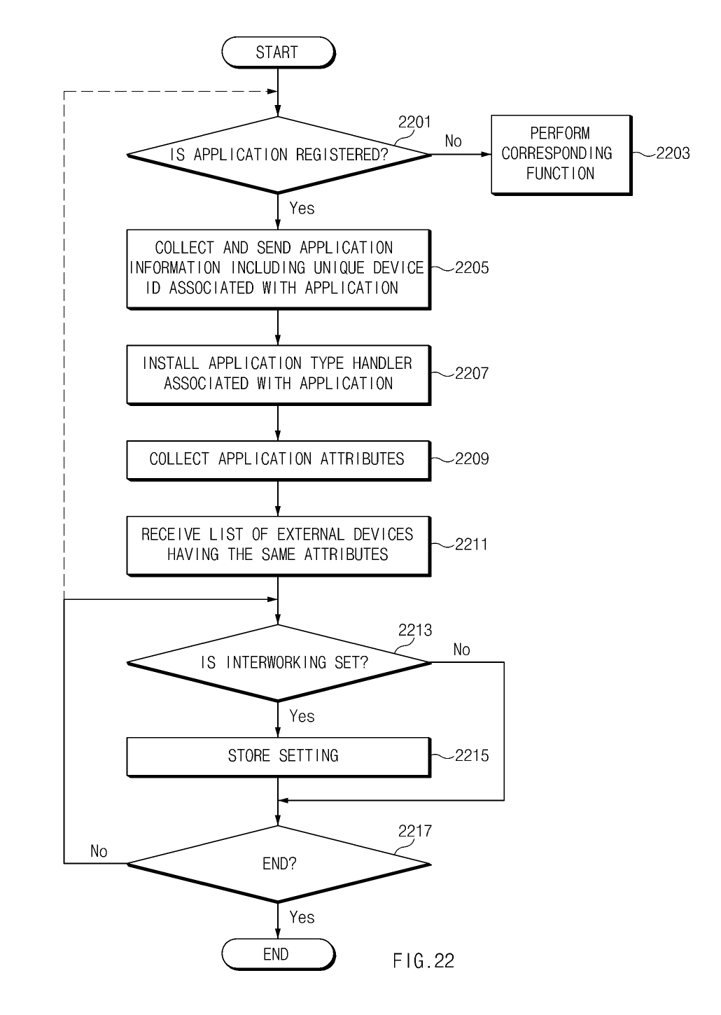

FIG. 22 is a flowchart illustrating a registration operation in an application operating method according to an embodiment of the present disclosure.

Referring now to FIG. 22, at operation 2201 of the application operating method according to an embodiment, an electronic device 100 of FIG. 1 may receive an event associated with registering an application. For example, the electronic device 100 may receive an event for requesting to install at least one application or an event for selecting an installed application. If an event which is not associated with registering the application is generated, at operation 2203, the electronic device 100 may perform a function based on a type of the generated event. For example, the electronic device 100 may perform a call function or a web surfing function and the like based on the type of generated event.

If the event associated with registering the application is generated, at operation 2205, the electronic device 100 may collect and send application information including a unique device ID associated with the application. For example, the electronic device 100 may collect application information included in an application program file and may send the collected application information to a device manager such as a hub 104 or a server 106 of FIG. 1.

At operation 2207, the electronic device 100 may install an application type handler associated with the application. If the electronic device 100 provides the application information to the device manager, the device manager may search an application type handler for operating the corresponding application as a device and may provide the application type handler to the electronic device 100. Alternatively, the electronic device 100 may provide application type handler information together when providing the application information to the device manager and may receive an application type handler from the device manager.

At operation 2209, the electronic device 100 may collect application attributes. For example, the electronic device 100 may determine whether the application has audio output attributes, video output attributes, or image acquisition attributes. The application attributes may be determined based on application information. The application may include at least one attributes. The application type handler may collect various attributes, such as an alarm, an audio, a video, power, and music reproduction, in connection with the application based on the application information.

At operation 2211, the electronic device 100 may receive a list of external devices having the substantially same attributes. The application type handler of the electronic device 100 may provide at least part of attributes of the application to the device manager and may receive a list of external devices having the substantially same attributes as the at least part of the attributes from the device manager. The electronic device 100 may output the received external device list. In this operation, the electronic device 100 may provide a list selection screen of external devices to interwork with the application.

At operation 2213, the electronic device 100 may determine whether an event associated with setting interworking is generated. For example, the electronic device 100 may receive an input for determining a type and operation attributes of an external device to operate together when the application is turned on. Alternatively, the electronic device 100 may receive an input for determining a type and operation attributes of an external device to operate when an application is turned off.

If the event associated with setting interworking is generated, at operation 2215, the electronic device 100 may store the setting. The electronic device 100 may store, for example, information about a list and operation attributes of external devices which interwork with the application in a mapping table. If the event associated with setting the interworking is not generated, the electronic device 100 may skip operation 2215.

At operation 2217, the electronic device 100 may determine whether an event associated with ending the registration of the application is generated. If the event associated with ending the registration of the application is not generated, the electronic device 100 may branch to operation 2213 and may perform the operation from operation 2213. According to various embodiments of the present disclosure, if an event which is not associated with ending the registration of the application is generated, for example, if an event associated with installing another application or selecting another installed application is generated, the electronic device 100 may branch to operation 2201 and may perform the operation from operation 2201.

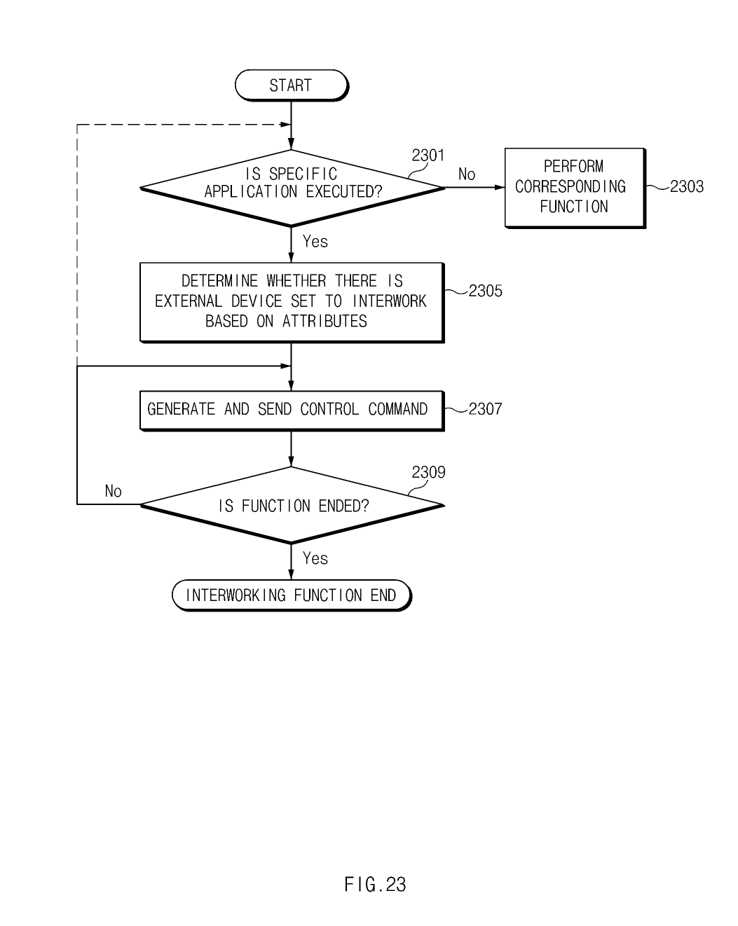

FIG. 23 is a flowchart illustrating a process of executing an operation in an application operating method according to an embodiment of the present disclosure.

Referring now to FIG. 23, in connection with executing an operation in the application operating method, at operation 2301, an electronic device 100 of FIG. 1 may determine whether an event for requesting to execute a specific application (e.g., an application registered as a device) is generated. For example, the electronic device 100 may output an icon or menu associated with executing the specific application. If the generated event is not associated with the specific application, at operation 2303, the electronic device 100 may perform a function based on a type of the generated event.

If the event for requesting to execute the specific application is generated, at operation 2305, the electronic device 100 may determine whether there is an external device set to interwork based on attributes. For example, the electronic device 100 may verify a mapping table and may determine whether there is an external device mapped to the selected application.

At operation 2307, if there is the external device mapped to the specific application, the electronic device 100 may generate and send a control command associated with controlling the external device. For example, the electronic device 100 may generate and send a control command to turn on the external device and a control command defined to perform a specific operation based on attributes of the external device. According to an embodiment, the electronic device 100 may send a control command to the corresponding external device through a hub 104 or a server 106 connected to the external device. According to various embodiments, if there is no external device set to interwork based on attributes, the electronic device 100 may skip operation 2207.

At operation 2309, the electronic device 100 may determine whether an event associated with ending the function (e.g., ending the execution of the specific application) is generated. If the event associated with ending the function is generated, the electronic device 100 may end/shut down the execution of the specific application. Also, the electronic device 100 may end/shut down the external device which operates to interwork with the specific application. In this regard, the electronic device 100 may generate a control command to instruct to end the external device and may send the generated control command to the corresponding external device. In this operation, the electronic device 100 may provide the control command to the hub 104 or the server 106 connected with the external device.

At operation 2309, if the event associated with ending the function is not generated, in operation 2307, the electronic device 100 may branch to operation 2307 and may generate and send a control command. For example, the electronic device 100 may output data, generated based on the execution of the specific application, through the external device. Alternatively, the electronic device 100 may send an operation control command, corresponding to data generated based on the execution of the specific application, periodically or in real time. According to various embodiments, if the event associated with ending the function is not generated, the electronic device 100 may branch to operation 2301, may monitor whether another specific application (e.g., an application registered as a device) is selected, and may perform a function based on the monitored result.

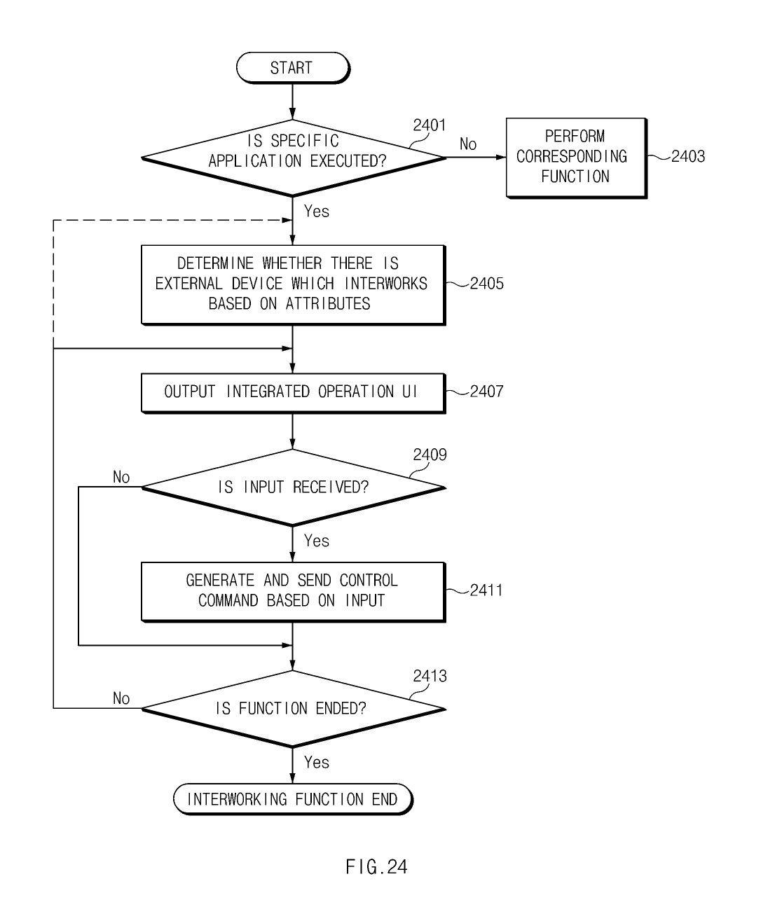

FIG. 24 is a flowchart illustrating operation control in an application operating method according to an embodiment of the present disclosure.

Referring to FIG. 24, in connection with controlling operation in the application operating method according to an embodiment, at operation 2401, an electronic device 100 of FIG. 1 may determine whether an event for requesting to execute a specific application is generated. If the generated event is not associated with executing the specific application, at operation 2403, the electronic device 100 may perform a function based on a type of the corresponding application.

If the event associated with executing the specific application is generated, at operation 2405, the electronic device 100 may determine whether there is an external device which interworks based on attributes. If there is an external device which interworks based on the attributes, at operation 2407, the electronic device 100 may output an integrated operation user interface (UI) associated with operating the specific application and the external device in an integrated way. The integrated operation UI may include a control window associated with controlling an operation of the application and a control window for controlling operation attributes of the external device.

At operation 2409, the electronic device 100 may determine whether an input associated with the integrated operation UI is received. If the input associated with the integrated operation UI is received, the electronic device 100 may generate and send a control command based on the input. If the input is not received, the electronic device 100 may skip operation 2409. According an embodiment, at operation 2411, if an input signal associated with controlling an operation of the application is generated, the electronic device 100 may control the operation of the application. Also, if an input for controlling an operation of a specific external device is generated, the electronic device 100 may generate a control command corresponding to the input and may send the generated control command to the external device.

At operation 2413, the electronic device 100 may determine whether an event associated with ending the function of the specific application is generated. If the event associated with ending the specific application is generated, the electronic device 100 may end the execution of the specific application. Also, the electronic device 100 may perform processing associated with ending/shutting down the external device which interworks with the specific application. For example, the electronic device 100 may write a control command associated with a specific external device and may send the control command to the corresponding external device. If the event associated with the function is not generated, the electronic device 100 may branch to operation 2407 or 2405 and may perform the operation again from operation 2407 or 2405.

As described above, in the application operating method, the electronic device 100 may register an application as the same device as an external device in a hub 104 or a server 106 of FIG. 1 and may set and operate external devices which may interwork with attributes of the application. Therefore, the electronic device 100 may improve the ease of use for the application and the external device.

According to an embodiment of the present disclosure, the electronic device 100 may register a healthcare application as a device such as an external device in a device manager. In this operation, the electronic device 100 may support operations such that sleep attributes of the healthcare application interwork with an illumination sensor, a light switch, or an audio device, and the like. Therefore, if a sleep application is executed, the electronic device 100 may operate the illumination sensor and may send a control command for adjusting a lighting level of the light switch to the device manager. Also, if the intensity of illumination of a specific level or more is sensed by the illumination sensor, the electronic device 100 may send a control command for waking up the user with the audio device or its audio application.

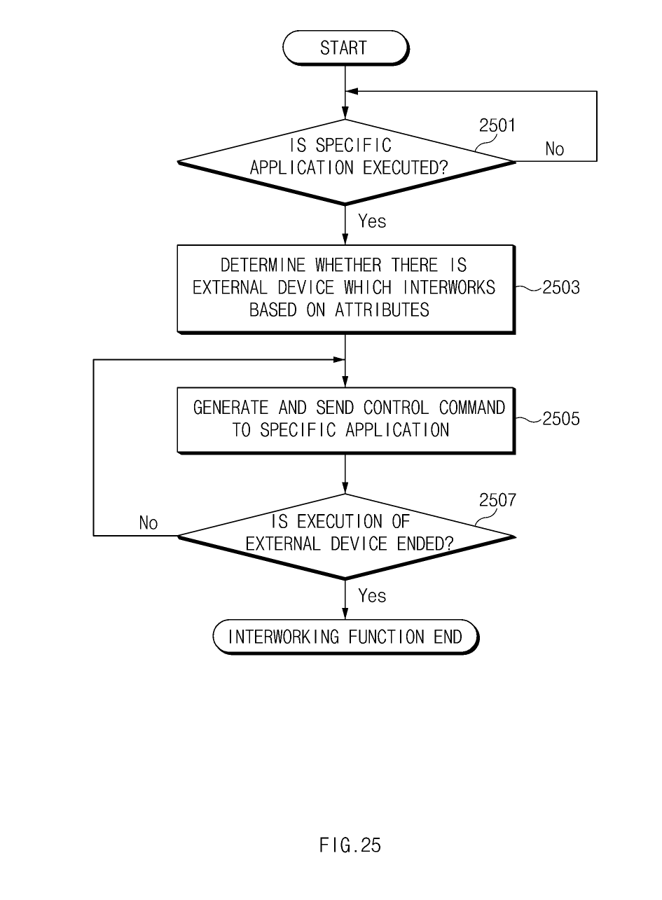

FIG. 25 is a flowchart illustrating a process of operating a device manager associated with operating another application according to an embodiment.

Referring to FIG. 25, in connection with operating the device manager, at operation 2501, the device manager may determine whether an event associated with executing a specific external device is generated. If the event associated with executing the specific external device is not generated, the device manager may return to operation 2501 and may perform the operation again from operation 2501.

If the event associated with executing the specific external device is generated, at operation 2503, the device manager may verify a setting for interworking based on attributes of an external device. For example, the device manager may detect a location of a user or an electronic device 100 of FIG. 1 using a presence sensor. If specific sensor information is collected by the presence sensor disposed in a specific location, the device manager may determine whether there is an external device or an application set to interwork with the presence sensor. According to various embodiments, if specific sensor information is collected from a contact sensor, a refrigerator door sensor, a fire detection sensor, a gas detection sensor, and the like, the device manager may determine whether there is a setting for interworking.

At operation 2505, if there is an application which interworks with the external device, the device manager may generate a control command and may send the generated control command to the specific application. The device manager may send the corresponding control command to the specific application through the electronic device 100. In this operation, an application type handler of the electronic device 100 may analyze the control command provided from the device manager and may determine whether to send the control command to any application. The application type handler may generate an operation command corresponding to the control command and may send the generated operation command to the corresponding application.

At operation 2507, the device manager may determine whether an event for ending the execution of the external device is generated. The device manager may end operation of the external device and may end the execution of the specific application which interworks with the external device. For example, the device manager may send a control command to instruct to end the execution of the specific application to the specific application. If the event associated with ending/shutting down the external device is not generated, the device manager may branch to operation 2505 and may perform the operation again from operation 2505.

According to various embodiments of the present disclosure, an application operating method may include requesting to execute an application based on a state where the application is registered as a device manager, in which at least one external device is registered and associated with the application, to operate as a device and the operating an external device, having the substantially same attributes as at least part of operation attributes of the application, in response to a specific setting.

According to various embodiments of the present disclosure, an application operating method may include receiving a request to perform a function which may be provided from at least one application, verifying at least one external device which may perform the function, and providing a list of the at least one application and the at least one external device.

According to various embodiments of the present disclosure, the method may further include outputting a control window associated with controlling the operation of the application and a control window associated with controlling the external device as one integrated user interface.

According to various embodiments of the present disclosure, the method may further include executing an application when an event for requesting to execute the application is generated and sending a control command, associated with controlling an external device, to the external device set to interwork with the application.

According to various embodiments of the present disclosure, the method may further include verifying a location of the electronic device based on executing a camera application, generating a control command for controlling a light switch at a point where the electronic device is located, and sending the generated control command to the light switch.

According to various embodiments of the present disclosure, the method may further include verifying a location of the electronic device based on executing a music application, generating a control command for controlling an external speaker of a point where the electronic device is located, and sending the generated control command to the external speaker.

According to various embodiments of the present disclosure, the method may further include selecting an audio output application to receive a control command received in response to an operation of a specific sensor and outputting a specific alarm through the audio output application.

According to various embodiments of the present disclosure, the method may further include generating a lighting control command in response to an operation of a sleep application and sending the lighting control command to a light switch.

According to various embodiments of the present disclosure, an application operating method may include receiving a control command in connection with the application and an external device having the same attributes as at least part of operation attributes of the application based on a state where an application is registered in a device manager, in which at least one external device is registered, to operate as a device and operating the application based on the control command.

According to various embodiments of the present disclosure, an application operating method may include receiving a control command in connection with an external device, having the same function as at least part of a function of an application, based on a state where the application is registered in a device manager, in which at least one external device is registered, such that the device manager processes operation of the application by recognizing the application as the external device and communicating with the application and operating the application based on the control command.

According to various embodiments of the present disclosure, the method may further include verifying an application to process the control command if the control command is received, converting the control command into a command to be processed in the application, and sending the converted command.

According to various embodiments of the present disclosure, the method may further include determining whether security of the control command is valid, processing the control command if the security of the control command is valid, and not processing the control command if the security of the control command is invalid.

According to various embodiments of the present disclosure, an application operating method may include receiving a request to perform a function which may be provided from at least one application, verifying at least one external device which may perform the function, and providing a list including the at least one application and the at least one external device.

According to various embodiments of the present disclosure, the method may further include registering the at least one application in a device manager to be recognized as a device, based on the function.

According to various embodiments of the present disclosure, the method may further include assigning a unique device identifier corresponding to the device to the at least one application.

According to various embodiments, the method may further include displaying a first window for controlling the at least one application or a second control window for controlling the at least one external device in connection with the function.

According to various embodiments of the present disclosure, the receiving of the request may include receiving an event for requesting to perform the function through the at least one application. The method may further include sending a control command for performing the function to the at least one external device in response to receiving the event.

According to various embodiments of the present disclosure, the at least one external device may include a plurality of external devices. The sending of the control command may include sending the control command to external devices paired with the at least one application among the plurality of external devices.

According to various embodiments of the present disclosure, the method may further include not sending the control command to external devices which are not paired with the at least one application among the plurality of external devices (in other words the at least one processor is configured to send the control command only to the external devices paired with the at least one application from among the plurality of external devices).

According to various embodiments of the present disclosure, the method may further include checking security validity of the control command and sending the control command to the at least one application if the security validity meets a specific condition.

According to various embodiments of the present disclosure, the method may further include verifying the at least one application associated with the function in response to receiving a control command set to perform the function in the at least one external device, converting the control command into a command set such that the at least one application processes the function, and sending the converted command to the at least one application.

According to various embodiments of the present disclosure, the method may further include determining a location of the electronic device, selecting a corresponding one of the at least one application and the at least one external device, and performing the function using the corresponding one.

According to various embodiments of the present disclosure, the method may further include receiving a request to perform another function before receiving the request to perform the function, determining operation association between the other function and the function, and providing the request to perform the function if the operation association meets a specific condition.

Each of the above-mentioned elements of the electronic device according to various embodiments of the present disclosure may be configured with one or more components, and names of the corresponding elements may be changed according to the type of the electronic device. The electronic device according to various embodiments of the present disclosure may include at least one of the above-mentioned elements, some elements may be omitted from the electronic device, or other additional elements may be further included in the electronic device. Also, some of the elements of the electronic device according to various embodiments of the present disclosure may be combined with each other to form one entity, thereby making it possible to perform the functions of the corresponding elements in the same manner as before the combination.

The terminology “module” used herein may mean, for example, a unit including one of hardware, software, and firmware or two or more combinations thereof. The terminology “module” may be interchangeably used with, for example, terminologies “unit”, “logic”, “logical block”, “component”, or “circuit”, and the like. The “module” may be a minimum unit of an integrated component or a part thereof. The “module” may be a minimum unit performing one or more functions or a part thereof. The “module” may be mechanically or electronically implemented. For example, the “module” may include at least one of an application-specific integrated circuit (ASIC) chip, field-programmable gate arrays (FPGAs), or a programmable-logic device, which is well known or will be developed in the future, for performing certain operations.

According to various embodiments of the present disclosure, at least part of a device (e.g., modules or the functions) or a method (e.g., operations) may be implemented with, for example, instructions stored in computer-readable storage media which have a program module. When the instructions are executed by a processor, one or more processors may perform functions corresponding to the instructions. The computer-readable storage media may be, for example, a memory.

The computer-readable storage media may include a hard disc, a floppy disk, magnetic media (e.g., a magnetic tape), optical media (e.g., a compact disc read only memory (CD-ROM) and a digital versatile disc (DVD)), magneto-optical media (e.g., a floptical disk), a hardware device (e.g., a ROM, a random access memory (RAM), or a flash memory, and the like), and the like. Also, the program instructions may include not only mechanical codes compiled by a compiler but also high-level language codes which may be executed by a computer using an interpreter and the like. The above-mentioned hardware device may be configured to operate as one or more software modules to perform operations according to various embodiments of the present disclosure, and vice versa.

According to various embodiments of the present disclosure, the electronic device may operate many-sided functions by operating a function of an application, installed in the electronic device, together with peripheral devices.

The apparatuses and methods of the disclosure can be implemented in hardwar e, and in part as firmware or via the execution of software or computer code in conjunction with hardware that is stored on a non-transitory machine readable medium such as a CD ROM, a RAM, a floppy disk, a hard disk, or a magneto-optical disk, or computer code downloaded over a network originally stored on a remote recording medium or a non-transitory machine readable medium and stored on a local non-transitory recording medium for execution by hardware such as by at least one processor, so that the methods described herein are loaded into hardware such as a general purpose computer, or a special processor or in programmable or dedicate d hardware, such as an ASIC or FPGA.

As would be understood in the art, the computer, the processor, microprocessor, controller, control unit or the programmable hardware include memory components, e.g., RAM, ROM, Flash, etc., that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor”, “microprocessor” “controller”, or “control unit” constitute hardware in the claimed disclosure that contain circuitry, such as integrated circuitry, that is configured for operation. The control unit/controller may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc.

Under the broadest reasonable interpretation, the appended claims constitute statutory subject matter in compliance with 35 U.S.C. §101 and none of the elements are software per se.

Nor are the claims directed to Abstract ideas, and constitute statutory subject matter under 35 U.S.C. §101.

The definition of the terms “unit” or “module” as referred to herein are to be understood as constituting hardware circuitry such as a CCD, CMOS, SoC, AISC, FPGA, at least one processor or microprocessor (e.g. a controller or control unit) configured for a certain desired functionality, or a communication module containing hardware such as transmitter, receiver or transceiver, or a non-transitory medium comprising machine executable code that is loaded into and executed by hardware for operation, in accordance with statutory subject matter under 35 U.S.C. §101 and do not constitute software per se.

Modules or program modules according to various embodiments of the present disclosure may include at least one or more of the above-mentioned components, some of the above-mentioned components may be omitted, or other additional components may be further included. Operations executed by modules, program modules, or other components may be executed by a successive method, a parallel method, a repeated method, or a heuristic method. Also, some operations may be executed in a different order or may be omitted, and other operations may be added. Embodiments of the present disclosure described and shown in the drawings are provided as examples to describe technical content and help understanding but do not limit the scope of the present disclosure. Accordingly, it should be interpreted that besides the embodiments listed herein, all modifications or modified forms derived based on the technical ideas of the present disclosure are included in the scope of the present disclosure as defined in the claims, and their equivalents.

What is claimed is:

1. An electronic device, comprising:
a memory configured to store at least one application; and
at least one processor configured to operatively communicate with the memory,
wherein the at least one processor is configured to:
receive a request to execute a function provided from the at least one application,
identify at least one external device which performs the requested function based on at least one attribute common to at least one application and the at least one external device stored in the memory, and
output a list including at least one of the at least one application and the at least one external device that executes the requested function.

2. The electronic device of claim 1, wherein the at least one processor is configured to register the at least one application in a device manager to be recognized as a device associated with the at least one external device, based on the requested function, wherein the device manager recognizes the at least one application of the electronic device as a device.

3. The electronic device of claim 2, wherein the at least one processor is configured to assign a unique device identifier corresponding to the application being recognized as a device to map the at least one application with the at least one external device.

4. The electronic device of claim 1, wherein the at least one processor is configured to display a first control window for controlling the at least one application or a second control window for controlling the at least one external device in connection with the requested function.

5. The electronic device of claim 1, wherein the at least one processor is configured to receive an event for requesting execution of the requested function through the at least one application and to send a control command to execute the requested function to the at least one external device in response to receiving the event.

6. The electronic device of claim 5, wherein the at least one external device comprises a plurality of external devices, and wherein the at least one processor is configured to send the control command only to the external devices paired with the at least one application from among the plurality of external devices.

7. The electronic device of claim 6, wherein the at least one processor is configured to check a security validity of the control command and to send the control command to the at least one application in response to the check of the security validity satisfying a condition.

8. The electronic device of claim 1, wherein the at least one processor is configured to:
identify at least one application associated with the requested function,
in response to receiving a control command, set the execution of the requested function in the at least one external device,
convert the control command into a command set in which the at least one application processes the requested function, and
send the converted control command to the at least one application.

9. The electronic device of claim 1, wherein the at least one processor is configured to:
determine a location of the electronic device,
select a corresponding one of the at least one application and the at least one external device based on the location, and
execute the requested function using the corresponding one of the at least one application and the at least one external device.

10. The electronic device of claim 1, wherein the at least one processor is configured to:
receive a request to execute another function prior to receiving the request to execute the function associated with the at least one application,
determine an operational association between said another function and the function, and
execute the function in response to the operational association satisfying a condition.

11. An application operating method, the method comprising:
receiving a request to execute a function provided from at least one application;
identifying at least one external device associated with executing the function; and
providing a list including at least one of the at least one application and the at least one external device that executes the requested function.

12. The method of claim 11, further comprising:
registering the at least one application in a device manager for recognition as a device, based on the function.

13. The method of claim 12, further comprising:
assigning a unique device identifier corresponding to the at least one application recognized as the device.

14. The method of claim 11, further comprising:
displaying a first control window for controlling the at least one application or a second control window for controlling the at least one external device in connection with the function.

15. The method of claim 11, wherein the receiving of the request comprises:
receiving an event for requesting execution of the function through the at least one application, and
sending a control command to execute the function to the at least one external device in response to receiving the event.

16. The method of claim 15, wherein the at least one external device comprises a plurality of external devices, and wherein the sending of the control command comprises:
at least one of sending the control command to only the external devices of the plurality of external devices paired with the at least one application among the plurality of external devices.

17. The method of claim 15, further comprising:
checking a security validity of the control command; and
sending the control command to the at least one application in response to checking the security validity satisfies a condition.

18. The method of claim 11, further comprising:
identifying at least one application associated with the function, in response to receiving a control command set to execute the function in the at least one external device;
converting the control command into a command set in which the at least one application processes the function; and
sending the converted command to the at least one application.

19. The method of claim 11, further comprising:
determining a location of an electronic device;
selecting a corresponding one of the at least one application and the at least one external device based on the location; and
executing the function using the corresponding one of the at least one application and the at least one external device.

20. The method of claim 11, further comprising:
receiving a request to execute another function, prior to receiving the request to execute the function;
determining an operational association between said another function and the function; and
execute the function in response to the operational association satisfying a condition.
